(19) United States
(12) Patent Application Publication
(10) Pub. No.: US 2026/0278279 A1
(43) Pub. Date: Sep. 17, 2026

(54) Trajectory-Governed Reasoning Control in Persistent Cognitive Systems

(71) Applicant: AtomBeam Technologies Inc., Moraga, CA (US)

(72) Inventors: Brian Galvin, Silverdale, WA (US); Alexandria Tucker, Urbana, IL (US)

(21) Appl. No.: 19/665,266

(22) Filed: May 1, 2026

Related U.S. Application Data
(63) Continuation-in-part of application No. 19/659,126, filed on Apr. 27, 2026.
Application No. 19/659,126 is a continuation-in-part of application No. 19/649,400, filed on Apr. 16, 2026.
Application No. 19/649,400 is a continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
Application No. 19/659,126 is a continuation-in-part of application No. 19/334,638, filed on Sep. 19, 2025.
Application No. 19/334,638 is a continuation-in-part of application No. 19/328,082, filed on Sep. 12, 2025, now Pat. No. 12,572,748.
Application No. 19/328,082 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,107, filed on Jul. 19, 2025.
(60) Provisional application No. 63/901,793, filed on Oct. 19, 2025.
(60) Provisional application No. 63/941,637, filed on Dec. 15, 2025.
(60) Provisional application No. 63/941,642, filed on Dec. 15, 2025.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/965,242, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.
(60) Provisional application No. 64/011,093, filed on Mar. 19, 2026.
(60) Provisional application No. 64/011,100, filed on Mar. 19, 2026.
(60) Provisional application No. 64/011,104, filed on Mar. 19, 2026.
(60) Provisional application No. 64/011,106, filed on Mar. 19, 2026.
(60) Provisional application No. 64/011,111, filed on Mar. 19, 2026.
(60) Provisional application No. 64/012,356, filed on Mar. 20, 2026.
(60) Provisional application No. 64/012,364, filed on Mar. 20, 2026.
(60) Provisional application No. 64/012,371, filed on Mar. 20, 2026.
(60) Provisional application No. 64/012,381, filed on Mar. 20, 2026.
(60) Provisional application No. 64/012,389, filed on Mar. 20, 2026.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for trajectory-governed reasoning control monitors reasoning trajectories through a geometric cognitive substrate in real time for epistemic coherence. A cognitive dynamics engine computes geodesic trajectories through a latent manifold under goal potential field influence. An epistemic connection on the manifold assigns transition-specific phase values encoding evidential consistency independently of semantic distance. A phase monitor accumulates epistemic phase along active trajectories, detecting coherence failures including phase drift, discontinuities, and holonomy descriptor conflicts. A loop classifier categorizes closed reasoning paths into coherent, drift, and inversion regimes, enforcing consolidation permission, corroboration requirements, or consolidation blocking respectively. An intervention executor implements backtracking, redirection, or interruption in response to monitoring signals. An output gating manager conditions response generation on trajectory admissibility, emitting full responses, qualifying responses with epistemic insufficiency indications, or suppressing output when no admissible trajectory supports a response.

### CROSS-REFERENCE TO RELATED APPLICATIONS

Priority is claimed in the application data sheet to the following patents or patent applications, each of which is expressly incorporated herein by reference in its entirety:
Ser. No. 19/659,126
Ser. No. 19/649,400
Ser. No. 19/550,709
Ser. No. 19/548,024
Ser. No. 19/546,407
Ser. No. 19/534,677
64/012,356
64/012,364
64/012,371
64/012,381
64/012,389
64/011,093
64/011,100
64/011,104
64/011,106
64/011,111
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
63/965,242
63/941,637
63/941,642
63/901,793
Ser. No. 19/334,638
Ser. No. 19/328,082
Ser. No. 19/321,173
Ser. No. 19/284,115
Ser. No. 19/051,193
63/847,082
63/847,091
63/847,096
63/847,101
63/847,107

### BACKGROUND OF THE INVENTION

### Field of the Invention

The present invention relates to the field of machine learning and artificial intelligence, particularly to systems for memory-augmented reasoning and long-term cognitive processing.

### Discussion of the State of the Art

Recent advances in artificial intelligence, particularly in large language models (LLMs), have significantly improved performance across a wide range of natural language processing, reasoning, and generation tasks. The underlying architectures typically rely on transformer-based models, which process sequences of tokens using stacked layers of self-attention, feedforward computation, and normalization. Despite producing fluent and contextually appropriate text, these models operate primarily in flat, static embedding spaces where each inference pass is performed independently with no intrinsic memory of past usage or prior reasoning pathways. These architectures are fundamentally stateless, lacking any persistent cognitive substrate in which prior reasoning steps, user interactions, or learned strategies can be stored, reused, or generalized.

Even in systems that implement geometric or manifold-based representations for persistent cognition, reasoning typically proceeds as a single-pass computation through the representational substrate. A query is encoded, a trajectory through the manifold is computed, and a response is decoded-all without monitoring the epistemic quality of the reasoning path as it unfolds. The trajectory is treated as a mathematical optimization problem to be solved, not as a dynamical process to be governed. No mechanism exists within such architectures to detect, during execution, that a reasoning trajectory has drifted from epistemically grounded territory into regions where evidential support is weak, contradictory, or absent.

This absence of in-execution monitoring creates a fundamental vulnerability. A trajectory that begins in well-supported semantic regions may gradually accumulate evidential drift as it passes through intermediate abstractions, crosses domain boundaries, or traverses regions of the representational space where prior experience is sparse. Each individual step along such a trajectory may appear locally reasonable, yet the cumulative effect is a conclusion that lacks epistemic justification. Current approaches to mitigating this vulnerability operate downstream of reasoning execution through post-hoc techniques such as confidence scoring, retrieval augmentation, self-consistency sampling, and reinforcement learning from human feedback. These mechanisms treat the output as the site of intervention rather than the reasoning process itself, and once an illegitimate trajectory has been computed and a conclusion formed, downstream filtering can only accept or reject the result—it cannot redirect the reasoning process toward more epistemically grounded territory, backtrack to a stable point and attempt an alternative path, or distinguish between conclusions that are merely unverified and those that are structurally inadmissible.

Furthermore, existing architectures provide no structural mechanism for classifying the degree of epistemic deviation encountered during reasoning or for implementing graduated responses proportional to that deviation. A reasoning path encountering mild evidential drift might benefit from corroboration through an independent trajectory rather than outright termination, while a path entering a region of severe epistemic inversion requires immediate intervention. Without continuous monitoring of a path-dependent coherence quantity during execution, such graduated responses are impossible.

What is needed is a system and method that governs reasoning trajectories as monitored dynamical processes rather than one-shot inferences, implementing real-time accumulation and assessment of a path-dependent epistemic coherence quantity during trajectory execution, classifying detected reasoning loops into graduated coherence regimes that determine whether conclusions may be consolidated, require independent corroboration, or must be blocked, and providing structured intervention mechanisms including backtracking to previously established stable points, redirection along alternative admissible paths, and conditional output gating that emits, qualifies, or suppresses responses based on the epistemic admissibility status of the trajectories that produced them.

### SUMMARY OF THE INVENTION

The inventor has developed a system and method for trajectory-governed reasoning control in which reasoning trajectories computed through a geometric cognitive substrate are monitored in real time for epistemic coherence, classified into graduated regime categories, and subjected to structured intervention when coherence degradation is detected-treating reasoning as a governed dynamical process rather than a one-shot inference. The system builds upon a Persistent Cognitive Machine (PCM) architecture in which a cognitive dynamics engine computes geodesic trajectories through a latent manifold under the influence of goal potential fields, and extends this architecture with an epistemic connection maintained on the manifold that assigns transition-specific phase values encoding evidential consistency independently of semantic distance, a trajectory monitoring and control layer that accumulates epistemic phase along active trajectories and detects coherence failures including phase drift, phase discontinuities, and holonomy descriptor conflicts during execution, a loop classifier that categorizes detected closed reasoning paths into coherent, drift, and inversion regimes based on magnitude of accumulated phase and enforces regime-appropriate responses including consolidation permission, corroboration requirements, and consolidation blocking, an intervention executor integrated within the cognitive dynamics engine that implements controlled backtracking to geometric anchors, redirection along alternative admissible geodesic paths, interruption, or suspension in response to monitoring signals, and an output gating manager that conditions response generation on trajectory admissibility status, emitting full responses from epistemically admissible trajectories, generating qualified responses with structured indications of epistemic insufficiency from partially admissible trajectories, and suppressing output when no admissible trajectory supports a response.

According to a preferred embodiment, a computer system comprising a hardware memory, wherein the computer system is configured to execute software instructions stored on nontransitory machine-readable storage media that: maintain a latent manifold as a geometric substrate for cognitive operations, wherein the latent manifold encodes semantic relationships between cognitive states through a semantic metric and additionally maintains an epistemic connection that assigns transition-specific phase values to edges connecting cognitive states independently of the semantic metric; compute geodesic trajectories through the latent manifold via a cognitive dynamics engine that minimizes a cognitive cost function incorporating traversal effort, compression pressure, and goal attraction; during traversal of a computed trajectory, accumulate an epistemic phase quantity along the trajectory by summing phase values assigned by the epistemic connection to each edge traversed; detect coherence failure conditions during traversal comprising at least one of phase drift beyond a threshold, a phase discontinuity, or a conflict among path-dependent descriptors applicable to a traversal location; upon detection of a closed reasoning loop, classify the loop into a phase regime based on magnitude of the accumulated epistemic phase, the phase regimes comprising a coherent regime in which consolidation is permitted, a drift regime in which consolidation is deferred pending corroboration, and an inversion regime in which consolidation is blocked; in response to detected coherence failure conditions or inadmissible phase regime classifications, execute intervention on the active trajectory comprising at least one of backtracking to a geometric anchor, redirection along an alternative admissible path, interruption of the trajectory, or suspension pending additional input; and condition output generation on trajectory admissibility status by emitting a response when the trajectory remains epistemically admissible, qualifying a response when an admissible prefix exists, or suppressing output when no admissible trajectory supports a response.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for a trajectory-governed reasoning control system built upon a Persistent Cognitive Machine foundation with integrated epistemic monitoring and intervention capabilities.

FIG. 2 is a block diagram illustrating an exemplary architecture of a component within a Persistent Cognitive Machine, a latent manifold.

FIG. 3 is a block diagram illustrating an epistemically conditioned manifold substrate maintaining a semantic metric, an almost-complex structure, a symplectic form, and an epistemic connection together implementing capacity constraints, admissibility boundaries, degeneracy regions, and structural gradients.

FIG. 4 is a block diagram illustrating an exemplary architecture of a component within a Persistent Cognitive Machine, a Cognitive Dynamics Engine.

FIG. 5 is a block diagram illustrating an exemplary architecture of a component within a Persistent Cognitive Machine, a goal manager.

FIG. 6 is a flow diagram illustrating holonomy and epistemic phase monitoring during reasoning traversal, including phase accumulation, discontinuity detection, loop regime classification, and corroboration evaluation.

FIG. 7 is a flow diagram illustrating an exemplary method for implementing persistent cognitive computation through geometric representation and manipulation of thoughts within a dynamic latent manifold.

FIG. 8 is a flow diagram illustrating an exemplary method for implementing reversible navigation within dynamic latent manifolds.

FIG. 9 is a flow diagram illustrating output generation and expression control conditioned on epistemic admissibility, including decoding, qualification, and suppression outcomes.

FIG. 10 illustrates an exemplary computing environment on which an embodiment described herein may be implemented.

### DETAILED DESCRIPTION OF THE INVENTION

The inventor has developed a system and method for trajectory-governed reasoning control in which reasoning trajectories computed through a geometric cognitive substrate are monitored in real time for epistemic coherence, classified into graduated regime categories, and subjected to structured intervention when coherence degradation is detected-treating reasoning as a governed dynamical process rather than a one-shot inference.

The system builds upon a Persistent Cognitive Machine (PCM) architecture in which a cognitive dynamics engine computes geodesic trajectories through a latent manifold under the influence of goal potential fields. The cognitive dynamics engine serves as the geometric substrate processor responsible for maintaining and evolving the structure of the latent manifold, computing geodesic paths by solving a variational problem that minimizes cognitive action while balancing kinetic energy of motion, compression pressure derived from semantic density, and attraction from goal potential fields. The latent manifold exists as a dynamic, evolving geometric space where cognitive states are represented as locations and reasoning processes as trajectories, with the manifold maintaining a semantic metric defining local distances, a connection governing parallel transport of attention, a Ricci curvature tensor measuring semantic density, compression pressure fields derived from curvature, and an attention vector field describing instantaneous cognitive flow. Within the manifold, thoughts exist as structured regions including thought bundles comprising compact submanifolds with their own internal geometry, geodesic trajectories representing paths of inference, and semantic fields comprising continuous distributions of meaning. A goal manager creates and maintains goal potential fields that shape how attention flows through the manifold during trajectory computation, generating scalar fields that attract cognitive processes toward semantically relevant regions and creating complex potential landscapes with multiple attractors, saddle points, and smooth gradients that guide exploration.

The system extends this foundation with an epistemic connection maintained on the latent manifold that assigns transition-specific phase values encoding evidential consistency independently of semantic distance. The epistemic connection is implemented as a U(1) connection on an epistemic line bundle over the manifold, assigning to each oriented edge a phase value representing evidential alignment between connected cognitive states. The curvature derived from the epistemic connection measures failure of parallel transport around loops to preserve evidential grounding, such that two regions of the manifold that are identical under the semantic metric may exhibit different epistemic curvature values reflecting different levels of evidential support. Edge phase values are assigned using an evidential consistency function comprising a source consistency component measuring agreement between evidential provenance of connected states, a cross-modal corroboration component measuring whether independent processing modalities support the association, and a temporal stability component measuring whether the relationship is consistent over time. The component values are combined to produce a composite evidential consistency value, and an edge phase is assigned by a monotone mapping such that full consistency maps to zero phase indicating trivial epistemic transport and zero consistency maps to a maximal phase value indicating maximal evidential misalignment. This dual-layer manifold structure, semantic geometry for trajectory computation and epistemic geometry for trajectory assessment, enables the system to distinguish between reasoning paths that are semantically plausible and those that are epistemically justified.

An encoder receives incoming data and maps each cognitive state to a provisional location on the latent manifold using semantic attachment. The provisional projection is not immediately incorporated into active traversal structures but is first evaluated for epistemic admissibility based on structural properties of the manifold including local capacity measures, admissibility boundary conditions, degeneracy indicators, and compatibility with path-dependent holonomy descriptors. Admission outcomes may include absorption, flagging at reduced commitment, boundary defect recording, or outright veto, ensuring that only states satisfying epistemic constraints enter the reasoning pipeline.

A trajectory monitoring and control layer receives trajectory events from a traversal subsystem within the cognitive dynamics engine during active reasoning and provides real-time epistemic assessment as trajectories are being computed and executed. A phase monitor within the trajectory monitoring and control layer accumulates an epistemic phase quantity along each active trajectory by summing scalar phase values assigned by the epistemic connection to each edge traversed, producing a quantitative measure of whether the trajectory maintains epistemic coherence as it moves through the latent manifold. The phase monitor detects epistemic instability not only upon explicit loop closure but also during open-path traversal, identifying phase discontinuities arising from abrupt shifts in abstraction level unsupported by prior experience, convergence of incompatible holonomy descriptors at a single manifold location, attempted traversal across suppressed homotopy classes, or emergence of partial loop structures exhibiting self-inconsistency.

A loop classifier receives accumulated phase information and classifies detected closed reasoning paths into phase regimes based on magnitude of the accumulated epistemic phase. A coherent regime is assigned when the magnitude of accumulated phase falls at or below a phase drift threshold, indicating that the reasoning loop maintained evidential coherence within tolerance and that consolidation of conclusions is permitted. A drift regime is assigned when the magnitude exceeds the phase drift threshold but remains below a higher bound, indicating significant epistemic drift requiring corroboration by an independent trajectory that reaches the same conclusion within a proximity threshold, maintains coherent phase, and is not deformable into the original trajectory within the manifold as constrained by admissibility boundaries or reservoir boundaries. An inversion regime is assigned when the magnitude equals or exceeds the higher bound, indicating irrecoverable misalignment between evidential grounding at the conclusion and at the start, blocking consolidation and marking the trajectory for suppression. This graduated classification enables proportional responses to varying degrees of epistemic uncertainty rather than binary accept-or-reject decisions.

An intervention executor integrated within the cognitive dynamics engine receives intervention signals from the trajectory monitoring and control layer and executes responsive modifications to active trajectories. The intervention executor implements controlled backtracking by inverting geometric flow dynamics through stored trajectories to return to a previously recorded geometric anchor, accounting for the original geodesic equations by reversing time parameters and negating compression pressure and goal field gradients. The intervention executor implements redirection by computing alternative admissible geodesic paths that avoid regions of detected instability while still pursuing the active goal potential field configuration. The intervention executor implements interruption and termination when detected instability is severe, and suspension pending clarification or additional input. The integration of the intervention executor within the cognitive dynamics engine enables intervention to be executed as modified geometric computations within the same substrate that computed the original trajectory, rather than as external overrides imposed from outside the reasoning process. Geometric anchors are created at significant locations during forward traversal where important choices were made, multiple paths diverged, or key insights emerged, with each anchor storing comprehensive local state information that enables precise return navigation.

A consolidation subsystem manages formation and stability of irreversible reservoirs within the latent manifold and processes trajectories determined to be epistemically inadmissible. Along a consolidation path, candidate regions approaching reservoir readiness are monitored through measurable precursors including curvature decay rate, phase coherence variance, barrier energy growth, and structural compatibility residual decay, with consolidation gated on concurrent satisfaction of epistemic admissibility, epistemic coherence or corroboration, and capacity admissibility. Along a suppression path, abstract constraint representations characterizing structural reasons for inadmissibility are generated and projected into irreversible reservoirs through non-invertible operations that discard reconstructable trajectory details while preserving information sufficient to identify structurally similar inadmissible patterns in subsequent reasoning. Asymmetric constraint feedback from the reservoirs influences subsequent admissibility evaluations and traversal decisions while active reasoning does not modify reservoir contents.

An output gating manager conditions response generation on trajectory admissibility status, computing a final admissibility determination as a logical conjunction of admission outcome, phase regime classification, and consolidation gate status. The output gating manager emits full responses from epistemically admissible trajectories, generates qualified responses with structured indications of epistemic insufficiency from partially admissible trajectories where an admissible prefix exists, and suppresses output when no admissible trajectory supports a response. This output conditioning ensures that the epistemic governance exercised throughout trajectory computation propagates to the final expression layer, preventing the system from confidently asserting conclusions that its own monitoring subsystems have identified as epistemically unsupported.

A manifold evolution subsystem updates geometric structures on separated timescales, with projection events perturbing local geometry on a fast timescale, a compression flow adjusting manifold coordinates on an intermediate timescale, and a connection relaxation flow reducing epistemic curvature on a slow timescale. The timescale ordering reflects experience accumulation preceding geometric adjustment and geometric adjustment preceding epistemic consolidation, and decreasing background epistemic curvature under the relaxation flow increases sensitivity of phase drift detection during subsequent trajectory traversal, such that the system becomes progressively more discriminating as accumulated experience refines the epistemic landscape.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “thought” refers to a discrete unit of reasoning or analysis generated by a large language model or multimodal inference engine during its processing of an input prompt. A thought represents the model's intermediate reasoning steps, contextual interpretation, or internal deliberation that contributes to a final output. Thoughts may be atomic (e.g., a factual claim), structured (e.g., an inference chain), or multimodal (e.g., a fused representation of text and video). Unlike raw tokens or embeddings, thoughts encapsulate processed cognition and are suitable for caching, recombination, and reuse across future interactions. Thoughts may be stored explicitly or synthesized during recall and may evolve through compression or generalization.

As used herein, “latent manifold” refers to a differentiable subspace within a high-dimensional latent hyperspace in which thoughts and thought trajectories are embedded. The manifold may be defined at a given time and is associated with a metric tensor that governs local distance, curvature, and motion. The manifold forms dynamically through the reuse, compression, and interaction of thoughts and supports operations such as geodesic traversal, memory recall, and structural recombination.

As used herein, “geodesic attention” refers to a formulation of attention in which focus or inference is achieved by computing or approximating a minimal-energy path through the latent manifold. A geodesic attention path minimizes a cognitive action functional that may include kinetic energy, compression pressure, and goal potential. Unlike traditional attention mechanisms that reweight tokens in flat space, geodesic attention produces smooth, structure-respecting flows of reasoning across latent memory.

As used herein, “compression pressure” refers to a scalar field over the latent manifold that encodes semantic density, memory reuse, or representational redundancy. The pressure at a point may be derived from geometric properties such as Ricci curvature and reflects the cost of traversal or storage in that region. High compression pressure indicates overused or ambiguous areas where pruning, generalization, or reorganization may be necessary. Compression pressure influences cache management, memory shaping, and geodesic routing.

As used herein, “goal potential field” refers to a scalar utility function defined over the latent manifold that represents the relevance, desirability, or task-alignment of different regions of thought space. The gradient of this field defines an intent vector field, which biases cognitive traversal toward goal-aligned areas. Goal potential may be determined by user prompts, task specifications, or emergent system objectives, and modulates attention, memory retrieval, and trajectory formation.

As used herein, “intent vector field” refers to a directional field over the latent manifold that encodes cognitive drive or utility gradients. It governs the direction and magnitude of traversal for operations such as memory reentry, inference, or exploration. The intent field may be computed from the gradient of a goal potential, derived from user input, or learned from system experience, and is used to align cognitive motion with target outcomes.

As used herein, “cognitive dynamics engine” or “CDE” refers to an architectural module configured to maintain and evolve the geometry of the latent manifold. The CDE is responsible for computing geodesic paths, estimating curvature, applying compression pressure, and performing structural reorganization, including during background operations such as dreaming. The CDE may expose interfaces for traversal, memory updates, compression, and control feedback, and functions as a substrate-layer system supporting high-level cognition.

As used herein, “dreaming” refers to a background process in which cached thoughts, trajectories, or bundles are perturbed, recombined, or abstracted or otherwise manipulated to improve manifold coherence and memory efficiency. Dreaming may operate during idle cycles or low-load periods and is driven by curvature smoothing, compression pressure, and generalization gain. The process supports the emergence of new thoughts, refinement of existing structures, and long-term memory consolidation.

As used herein, “memory basin” or “basin of recurrence” refers to a region of the latent manifold associated with a previously reinforced or frequently reused trajectory. Such basins exhibit high local curvature and geodesic convergence and serve as attractors for memory reentry. Traversal into a basin may trigger reinstantiation, memory reinforcement, or adaptive reuse, depending on system configuration and goal conditions.

As used herein, “attention vector field” refers to a distributed, time-dependent field defined over the latent manifold that governs the instantaneous direction and magnitude of attentional flow. The field may evolve according to partial differential equations that incorporate compression pressure and goal potential gradients. This dynamic attention formulation enables real-time flow modeling, inference stabilization, and explainability through traceable vector paths.

As used herein, “latent subspace” or “thought bundle” refers to a localized, compressible region of the manifold that contains structurally similar or semantically aligned thoughts. Bundles may form naturally through repeated traversal, co-activation, or recombination, and act as low-energy attractors or semantic zones. Subspaces may support generalization, analogical reasoning, and efficient memory access.

As used herein, “epistemic connection” refers to a geometric structure maintained on the latent manifold that assigns transition-specific phase values to edges connecting cognitive states in a manner that is geometrically independent of the semantic metric. The epistemic connection encodes evidential consistency between adjacent cognitive states, such that two regions of the manifold that are identical under the semantic metric may exhibit different epistemic curvature values reflecting different levels of evidential support.

As used herein, “epistemic phase” or “accumulated epistemic phase” refers to a path-dependent coherence quantity computed by summing scalar phase values assigned by the epistemic connection to each edge traversed along a reasoning trajectory. The accumulated epistemic phase represents total evidential drift along a reasoning path and provides a quantitative measure of whether a trajectory maintains epistemic coherence as it moves through the latent manifold.

As used herein, “phase regime” or “loop regime classification” refers to a categorization of a detected closed reasoning path based on the magnitude of accumulated epistemic phase. A coherent regime is assigned when the magnitude of accumulated phase falls at or below a phase drift threshold, indicating that the reasoning loop maintained evidential coherence and that consolidation of conclusions is permitted. A drift regime is assigned when the magnitude exceeds the phase drift threshold but remains below a higher bound, indicating significant epistemic drift and that consolidation is deferred pending corroboration. An inversion regime is assigned when the magnitude equals or exceeds the higher bound, indicating that evidential grounding at the conclusion is misaligned beyond recovery with grounding at the start, that consolidation is blocked, and that the trajectory is marked for suppression.

As used herein, “phase discontinuity” refers to a structural inconsistency detected during traversal of a cognitive trajectory indicating loss of epistemic coherence prior to completion of a closed reasoning path. Phase discontinuities may arise from abrupt shifts in abstraction level unsupported by prior experience, convergence of incompatible holonomy descriptors at a single manifold location, attempted traversal across suppressed homotopy classes, or emergence of partial loop structures exhibiting self-inconsistency. Phase discontinuities are detected during open-path traversal and may trigger intervention without requiring loop closure.

As used herein, “holonomy descriptor” refers to a path-dependent quantity maintained for the latent manifold that encodes experiential effects accumulated along prior reasoning trajectories. Holonomy descriptors record how evidential grounding transforms under transport along specific paths, and their compatibility at a given manifold location reflects whether reasoning paths arriving from different directions produce consistent epistemic assessments. Incompatible holonomy descriptors at a traversal location indicate contradictory epistemic influences and are treated as hallucination precursors.

As used herein, “corroboration” refers to a requirement imposed on conclusions reached along trajectories classified in the drift regime, wherein consolidation of a conclusion is permitted only when an independent corroborating trajectory satisfies three conditions: the corroborating trajectory reaches a cognitive state within a proximity threshold of the original conclusion under the semantic metric; the corroborating trajectory maintains accumulated epistemic phase within the coherent regime; and the corroborating trajectory is not deformable into the original trajectory within the latent manifold as constrained by admissibility boundaries or consolidated region boundaries. The non-deformability condition ensures that the corroborating trajectory traverses genuinely different epistemic territory rather than a trivial variation of the original path.

As used herein, “geometric anchor” refers to a stored record of local manifold state created at a significant location during forward trajectory traversal where important choices were made, multiple paths diverged, or key insights emerged. Each geometric anchor stores comprehensive local state information including the complete geometric configuration, available path options and their initial directions, decision criteria and goal states active at that point, and semantic context. Geometric anchors serve as cognitive waypoints that enable efficient backtracking to important reasoning states without requiring full trajectory replay.

As used herein, “evidential consistency function” refers to a composite function used to assign edge phase values in the epistemic connection, comprising a plurality of component functions combined to produce a scalar consistency value for each pair of cognitive states connected by an edge. Component functions may include a source consistency component measuring agreement between evidential provenance of connected states, a cross-modal corroboration component measuring whether independent processing modalities support the association, and a temporal stability component measuring whether the relationship is consistent over time. The composite value is mapped to a phase interval by a monotone mapping such that full consistency maps to zero phase and zero consistency maps to maximal phase.

As used herein, “trajectory governance” or “trajectory monitoring” refers to the real-time monitoring and control of reasoning trajectories during execution, in which epistemic phase is continuously accumulated, coherence failure conditions are detected, phase regimes are classified, and intervention signals are generated when coherence degradation exceeds defined thresholds. Trajectory governance treats reasoning as a dynamical process subject to continuous assessment rather than as a one-shot inference producing an output to be evaluated after the fact.

As used herein, “output gating” or “epistemic gating” refers to the conditioning of output generation on trajectory admissibility status as determined by trajectory governance. Output gating evaluates admission outcome, phase regime classification, and consolidation status, and produces one of three outcomes: emission of a full response when the trajectory remains epistemically admissible, generation of a qualified response with structured indications of epistemic insufficiency when an admissible prefix of the trajectory exists, or suppression of output when no admissible trajectory supports a response.

As used herein, “intervention” refers to a corrective action executed during trajectory traversal in response to detected coherence failures, comprising one or more of controlled backtracking to a previously established geometric anchor, redirection toward an alternative admissible geodesic path that avoids the region of detected instability, interruption and termination of the trajectory, suspension pending clarification or additional input, or marking the trajectory for subsequent suppression. The choice among intervention mechanisms may depend on severity of detected instability, proximity to consolidated regions, and availability of alternative admissible paths.

### Conceptual Architecture

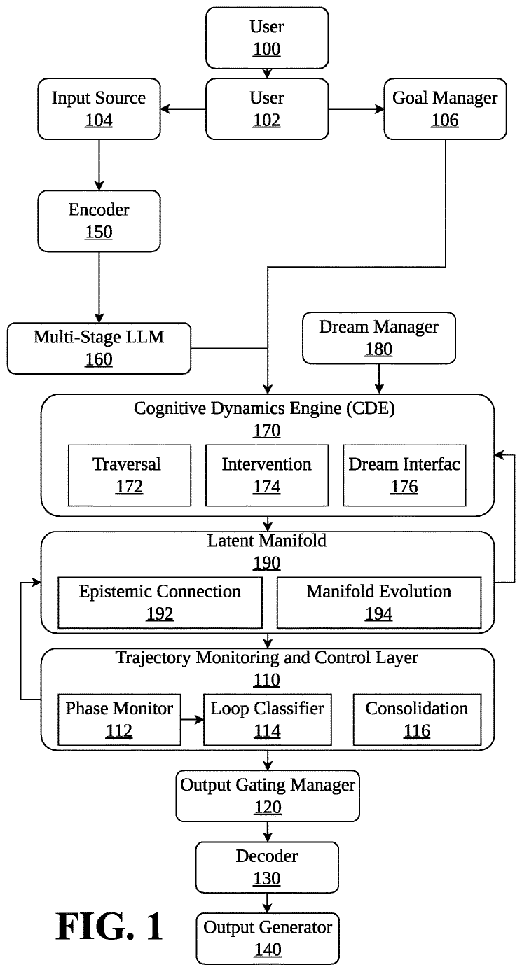

FIG. 1 is a block diagram illustrating an exemplary system architecture for a trajectory-governed reasoning control system built upon a Persistent Cognitive Machine foundation with integrated epistemic monitoring and intervention capabilities. A user 100 interacts with the system through a user interface 102, which serves as the primary interaction layer receiving natural language queries, commands, or other forms of input while presenting processed outputs. User interface 102 channels incoming data to an input source 104, which aggregates various data streams including multimodal inputs such as text, images, audio, sensor data, and system state information. Input source 104 also receives goal specifications and task objectives from user 100 and forwards them to a goal manager 106, which creates and maintains goal potential fields that shape how attention flows through the manifold during trajectory computation. Goal manager 106 generates scalar fields over the manifold that attract cognitive processes toward semantically relevant regions, creating complex potential landscapes with multiple attractors for competing objectives, saddle points where decisions must be made, and smooth gradients that guide exploration. Goal manager 106 continuously updates these fields based on changing objectives and feedback, producing a dynamic landscape that guides inference and reasoning processes. In an embodiment, goal manager 106 implements field generation algorithms that create unified potential landscapes spanning multiple semantic domains when complex queries require interdisciplinary expertise.

An encoder 150 receives data from input source 104 and transforms incoming cognitive states into geometric representations suitable for embedding within latent manifold 190. Encoder 150 does not simply create vector embeddings but rather projects inputs into a dynamic geometric space where semantic relationships are encoded through curvature, distance, and topological structure, mapping each incoming cognitive state to a provisional location on latent manifold 190 using semantic attachment such as harmonic extension from nearby landmark states. The encoding process is context-sensitive and adaptive, taking into account the current state of latent manifold 190 and the compression pressure at different regions. Encoder 150 additionally evaluates each provisional location against structural properties of latent manifold 190 prior to incorporating the provisional location into active reasoning, functioning as an epistemic admission gate within the encoding pipeline. In an embodiment, encoder 150 evaluates epistemic admissibility based on one or more structural properties including a local capacity measure derived from a symplectic form maintained on latent manifold 190, an admissibility boundary condition derived from barrier energy at boundaries of consolidated regions, a degeneracy indicator based on epistemic curvature magnitude, or compatibility with path-dependent holonomy descriptors maintained for latent manifold 190. When the epistemic admissibility is not satisfied, encoder 150 denies admission by preventing formation of a reasoning trajectory from the provisional location. In an embodiment, encoder 150 classifies admission outcomes as absorption, in which the state is fully incorporated into latent manifold 190; flagging, in which the state may participate in reasoning at reduced commitment but is excluded from consolidation until stabilization; defect, in which a boundary event is recorded when the provisional state near a reservoir boundary exhibits excessive curvature or phase drift; or veto, in which insertion is prevented when capacity constraints are violated.

A multi-stage LLM 160 serves as a language processing component that works in conjunction with encoder 150 to generate semantic structures from raw inputs. Multi-stage LLM 160 functions as a component within the larger system, providing sophisticated natural language understanding and generation capabilities while being guided by the geometric constraints of latent manifold 190. Multi-stage LLM 160 processes inputs through multiple stages of refinement, creating increasingly abstract and structured representations that can be properly embedded within latent manifold 190. In an embodiment, multi-stage LLM 160 may be implemented using any appropriate language model architecture, including transformer-based models, with potential specialization through domain-specific fine-tuning or prompt engineering techniques. The multi-stage processing may be implemented through iterative passes through a single model, chained processing through multiple specialized models, hierarchical processing from coarse to fine-grained analysis, or parallel processing with subsequent integration.

A cognitive dynamics engine (CDE) 170 serves as the geometric substrate processor and core architectural component responsible for maintaining and evolving the structure of latent manifold 190. Operating analogously to a physics engine in a simulation environment, CDE 170 governs the fundamental geometric operations that enable persistent cognition, including computing geodesic paths for attention traversal, estimating curvature, applying compression pressure, and performing structural reorganization. CDE 170 computes geodesic paths by solving a variational problem that minimizes cognitive action, balancing kinetic energy of motion, compression pressure from semantic density, and attraction from goal potential fields generated by goal manager 106. During active cognition, CDE 170 continuously computes Ricci curvature across latent manifold 190, deriving a compression pressure field that penalizes traversal through semantically dense regions, and manages the evolution of an attention vector field that enables attention to flow as a cognitive fluid through shaped space. CDE 170 exposes interfaces for traversal, memory updates, compression, and control feedback, and functions as a substrate-layer system supporting high-level cognition. CDE 170 contains several integrated subsystems that collectively enable trajectory-governed reasoning.

A traversal subsystem 172 within CDE 170 computes cognitive trajectories through latent manifold 190 from admitted initial states, subject to admissibility constraints encoded in manifold geometry. Traversal subsystem 172 constructs reasoning pathways by identifying optimal geodesic paths through the manifold using the variational methods implemented by CDE 170, navigating through thought bundles comprising coherent submanifolds while retrieving relevant stored thoughts based on geometric proximity, semantic alignment, and contextual appropriateness. As trajectories are computed and executed, traversal subsystem 172 generates trajectory events comprising edge traversals, position updates, and contextual information associated with each active cognitive trajectory, and forwards these events to a trajectory monitoring and control layer 110 for real-time epistemic assessment. In an embodiment, traversal subsystem 172 maintains complete trajectory information during forward traversal, capturing the precise coordinates of each point along the path, the velocity and acceleration of attention movement, local curvature values and metric tensor components at each position, and the compression pressure and goal potential fields encountered, creating a comprehensive record that enables both reasoning traceability and potential backtracking. In an embodiment, traversal subsystem 172 creates geometric anchors at significant locations in the cognitive journey where important choices were made, multiple paths diverged, or key insights emerged, with each anchor storing comprehensive local state information including the complete geometric configuration, available path options, decision criteria, and semantic context.

An intervention executor 174 within CDE 170 receives intervention signals from trajectory monitoring and control layer 110 and executes responsive modifications to active trajectories. When phase monitor 112 or loop classifier 114 within trajectory monitoring and control layer 110 detects epistemic instability or inadmissible phase accumulation during traversal, intervention executor 174 modifies traversal control structures to implement corrective action. Intervention executor 174 may implement several distinct intervention mechanisms depending on severity of detected instability, proximity to consolidated regions, and availability of alternative admissible paths. In an embodiment, intervention executor 174 implements controlled backtracking to a previously recorded geometric anchor by inverting geometric flow dynamics through stored trajectories, reversing the mathematical operations that generated forward motion to create precise backward paths through the evolved manifold, accounting for the original geodesic equations by reversing time parameters, the influence of compression pressure and goal fields by negating their gradients, and the effects of manifold evolution by applying inverse transformations. In an embodiment, intervention executor 174 implements redirection by computing an alternative admissible geodesic path through CDE 170 that avoids the region of detected instability while still pursuing the active goal potential field configuration maintained by goal manager 106. In an embodiment, intervention executor 174 implements interruption and termination of a trajectory when the detected instability is severe, such as when an inversion regime is detected, and marks the trajectory for subsequent processing by consolidation 116. In an embodiment, intervention executor 174 implements suspension of traversal pending clarification or additional input from user 100. The integration of intervention executor 174 within CDE 170 enables intervention to be executed as modified geometric computations within the same substrate that computed the original trajectory, rather than as external overrides imposed from outside the reasoning process.

A dream interface 176 within CDE 170 provides a connection point between CDE 170 and a dream manager 180, enabling autonomous manifold reorganization during off-task periods. Dream interface 176 exposes methods for initiating various dreaming operations including targeted perturbation of specific manifold regions, global relaxation processes that smooth unnecessary complexity, and exploratory synthesis of new conceptual connections. Dream manager 180 implements autonomous structural reorganization of latent manifold 190 during off-task periods, analogous to sleep-driven memory consolidation in biological systems. Dream manager 180 initiates and oversees geometric restructuring operations that improve manifold efficiency and generalization capacity through perturbation, recombination, and topological transformations. During dreaming phases, dream manager 180 samples recently activated or frequently used thought bundles and applies stochastic perturbations informed by local curvature and uncertainty, testing stability and compressibility of cognitive structures and identifying opportunities for consolidation or abstraction.

A latent manifold 190 represents the central geometric substrate where all cognitive operations occur, existing as a dynamic, evolving space with rich internal structure. Unlike static embedding spaces in traditional architectures, latent manifold 190 is a continuously adapting geometry shaped by cognitive activity, with frequently traversed regions developing distinct topological features, semantic neighborhoods forming through repeated association, and compression pressure creating a non-uniform landscape that guides efficient reasoning. Within latent manifold 190, thoughts exist as structured regions including thought bundles comprising compact submanifolds representing coherent concepts, geodesic trajectories representing paths of inference and association, and semantic fields comprising continuous distributions of meaning and relevance. Latent manifold 190 maintains several critical geometric structures including a metric tensor defining local distances, a connection governing parallel transport of attention, a Ricci curvature tensor measuring semantic density, compression pressure fields derived from curvature, goal potential fields attracting attention, and an attention vector field describing instantaneous cognitive flow. Latent manifold 190 exhibits emergent topological features such as attractor basins where frequently accessed concepts stabilize, high-curvature regions indicating semantic compression, low-pressure corridors enabling efficient inference, and bridge structures connecting previously disparate domains.

An epistemic connection 192 maintained on latent manifold 190 assigns transition-specific phase values to edges connecting cognitive states in a manner that is geometrically independent of the semantic metric. Epistemic connection 192 encodes evidential consistency between adjacent cognitive states, such that two regions of latent manifold 190 that are identical under the semantic metric may nevertheless exhibit different epistemic curvature values reflecting different levels of evidential support. In an embodiment, epistemic connection 192 is implemented as a U(1) connection on an epistemic line bundle over latent manifold 190, assigning to each oriented edge a phase value that represents evidential alignment between the connected states. The curvature derived from epistemic connection 192 measures failure of parallel transport around infinitesimal loops to preserve evidential grounding. In an embodiment, epistemic connection 192 assigns edge phase values using an evidential consistency function comprising a source consistency component measuring agreement between evidential provenance of connected states, a cross-modal corroboration component measuring whether independent processing modalities support the association, and a temporal stability component measuring whether the relationship is consistent over time. The component values are combined to produce a composite evidential consistency value, and an edge phase is assigned by a monotone mapping from the composite consistency value to a phase interval, such that full consistency maps to zero phase indicating trivial epistemic transport along the edge and zero consistency maps to a maximal phase value indicating maximal evidential misalignment. Epistemic connection 192 provides the phase values that phase monitor 112 accumulates during trajectory traversal to assess epistemic coherence.

A manifold evolution subsystem 194 updates geometric structures maintained on latent manifold 190 on separated timescales reflecting different rates of geometric change. On a fast timescale, manifold evolution subsystem 194 incorporates projection events from encoder 150 that locally perturb the semantic metric together with interpolated structures and edge phases incorporated into epistemic connection 192. On an intermediate timescale, manifold evolution subsystem 194 applies a compression flow that adjusts manifold coordinates to minimize a geometric energy that enforces compatibility among geometric structures of latent manifold 190. On a slow timescale, manifold evolution subsystem 194 applies a connection relaxation flow that reduces epistemic curvature across latent manifold 190 through incremental phase updates, while evidence-driven updates modify individual edge phases in response to new input. The timescale ordering reflects experience accumulation preceding geometric adjustment and geometric adjustment preceding epistemic consolidation. In an embodiment, decreasing background epistemic curvature under the connection relaxation flow increases sensitivity of detection of phase drift during traversal of reasoning trajectories, such that the system becomes progressively more discriminating as accumulated experience refines the epistemic landscape.

A trajectory monitoring and control layer 110 receives trajectory events from traversal subsystem 172 during active reasoning and provides real-time epistemic assessment of reasoning trajectories as they are being computed and executed by CDE 170. Trajectory monitoring and control layer 110 implements monitoring of reasoning as a dynamical process rather than a one-shot inference, treating each trajectory as a governed process subject to continuous coherence evaluation with the authority to intervene during execution. Trajectory monitoring and control layer 110 comprises several integrated monitoring components that collectively implement multi-stage trajectory governance.

A phase monitor 112 within trajectory monitoring and control layer 110 accumulates an epistemic phase quantity Φ(γ) along each active trajectory by summing scalar phase values assigned by epistemic connection 192 to each edge traversed during reasoning. The accumulated phase represents total evidential drift along the reasoning path and provides a quantitative measure of whether the trajectory maintains epistemic coherence as it moves through latent manifold 190. Phase monitor 112 detects epistemic instability not only upon explicit loop closure but also during open-path traversal before any loop closure event occurs. Phase discontinuities detectable by phase monitor 112 may arise from abrupt shifts in abstraction level unsupported by prior experience, convergence of incompatible holonomy descriptors at a single manifold location, attempted traversal across suppressed homotopy classes, or emergence of partial loop structures exhibiting self-inconsistency. Phase monitor 112 monitors whether transported holonomy descriptors from different source paths produce contradictory phase assessments at a current traversal location, and when incompatible holonomy descriptors exert contradictory influence, the resulting degradation of epistemic phase coherence is treated as a hallucination precursor rather than as an ambiguous but permissible reasoning state. When phase monitor 112 detects a phase discontinuity or instability condition, it signals intervention executor 174 within CDE 170 to modify the active trajectory.

A loop classifier 114 within trajectory monitoring and control layer 110 receives accumulated phase information from phase monitor 112 and classifies detected closed reasoning paths into phase regimes based on magnitude of the accumulated epistemic phase. Loop classifier 114 implements a three-regime classification scheme. A coherent regime is assigned when the magnitude of accumulated phase satisfies |Φ(γ)|≤Φ*, indicating that the reasoning loop maintained evidential coherence within tolerance and that consolidation of conclusions drawn along the loop is permitted. A drift regime is assigned when the magnitude satisfies Φ*<|Φ(γ)|<π, indicating that the loop accumulated significant epistemic drift and that consolidation is deferred pending corroboration by an independent trajectory. An inversion regime is assigned when the magnitude satisfies |Φ(γ)|≥π, indicating that evidential grounding at the conclusion is misaligned with grounding at the start beyond recovery, that consolidation is blocked, and that the trajectory is marked for subsequent suppression. For a trajectory classified in the drift regime, loop classifier 114 evaluates whether an independent corroborating path γ′ satisfies three conditions: γ′ reaches a cognitive state within a proximity threshold of the conclusion reached by the original trajectory; γ′ maintains accumulated epistemic phase within the coherent regime; and γ′ is not deformable into the original trajectory within the latent manifold as constrained by admissibility boundaries or reservoir boundaries. When corroboration is satisfied, the drift-regime conclusion may proceed toward output generation. When corroboration is not satisfied, loop classifier 114 signals intervention executor 174 to implement redirection, backtracking, or termination. In an embodiment, loop classifier 114 forwards phase regime classifications together with curvature type decomposition into components compatible and incompatible with an almost-complex structure maintained on latent manifold 190 to consolidation 116 for use in boundary event classification and consolidation gating.

A consolidation subsystem 116 within trajectory monitoring and control layer 110 manages formation and stability of irreversible reservoirs within latent manifold 190 and processes trajectories determined to be epistemically inadmissible. Consolidation 116 operates along two complementary processing paths. Along a consolidation path, consolidation 116 monitors candidate regions of latent manifold 190 that approach reservoir readiness by tracking measurable precursors including curvature decay rate under connection relaxation, phase coherence variance over representative internal loops, barrier energy growth at region boundaries, and structural compatibility residual decay. A region of latent manifold 190 is recognized as a consolidated irreversible reservoir when the region satisfies epistemic curvature flatness below a flatness threshold, boundary energy exceeding a barrier threshold sufficient to resist perturbation from external cognitive activity, and boundary-aware admission control routing compatible cognitive states into the region while excluding incompatible states. Consolidation 116 gates consolidation on concurrent satisfaction of epistemic admissibility at the admission stage, epistemic coherence or corroboration at the traversal monitoring stage, and capacity admissibility at the consolidation stage. Along a suppression path, consolidation 116 receives trajectories marked as epistemically inadmissible by loop classifier 114 and generates abstract constraint representations characterizing structural reasons for inadmissibility, then projects those representations into irreversible reservoirs through a non-invertible operation that discards reconstructable trajectory details while preserving information usable to identify structurally similar inadmissible patterns in subsequent reasoning. Consolidation 116 provides asymmetric constraint feedback from the irreversible reservoirs to influence subsequent admissibility evaluations performed by encoder 150 and subsequent traversal decisions, wherein active reasoning does not modify contents of the irreversible reservoirs. In an embodiment, consolidation 116 supports localized revision of consolidated regions when persistent contradictory boundary events accumulate beyond a revision threshold, with restructuring limited to vertices and faces within a bounded geodesic radius of the boundary defect cluster.

An output gating manager 120 receives trajectory endpoints from traversal subsystem 172, phase regime classifications from loop classifier 114, and consolidation status from consolidation 116, and computes a final admissibility determination for completed trajectories. Output gating manager 120 evaluates a logical conjunction of status indicators, wherein admissibility requires an absorb or admitted outcome at the admission evaluation performed by encoder 150, a coherent or corroborated phase regime classification during traversal as determined by loop classifier 114, and a true consolidation gate flag as determined by consolidation 116. When the trajectory remains epistemically admissible, output gating manager 120 permits execution of decoding routines by a decoder 130, which transforms admissible cognitive states or trajectory results from geometric representations within latent manifold 190 back into interpretable outputs. When the trajectory does not remain fully admissible but a stored admissible prefix of the trajectory exists corresponding to a portion that maintained coherent phase status prior to detection of incoherence, output gating manager 120 permits generation of a qualified or partial response derived solely from cognitive states associated with the admissible prefix, and includes structured indications of epistemic insufficiency corresponding to detected evidential gaps. When no admissible prefix is available, output gating manager 120 suppresses invocation of decoding routines and instead generates a suppression response comprising withholding a response, requesting clarification or additional input, or deferring response to a later time. Decoder 130 works in conjunction with multi-stage LLM 160 to generate natural language outputs guided by the geometric structures extracted from latent manifold 190, with the decoding process taking into account not just the final position reached through inference but the entire trajectory taken, enabling explanations that reflect the reasoning process rather than just conclusions.

An output generator 140 serves as the final stage in the processing pipeline, taking decoded representations from decoder 130 and formatting them appropriately for user consumption through user interface 102. Output generator 140 handles multiple output modalities including natural language responses, visualizations of reasoning paths, actions or commands for external systems, and structured data formats. The feedback loop from output generator 140 back to user 100 through user interface 102 completes the interaction cycle, enabling iterative refinement and continuous learning. The response generated by output generator 140 simultaneously triggers updates to latent manifold 190 through manifold evolution subsystem 194, strengthening frequently traversed paths through metric adjustment, increasing curvature around newly important semantic regions, and adjusting bundle boundaries to reflect evolved understanding, such that future cognitive operations benefit from accumulated experience.

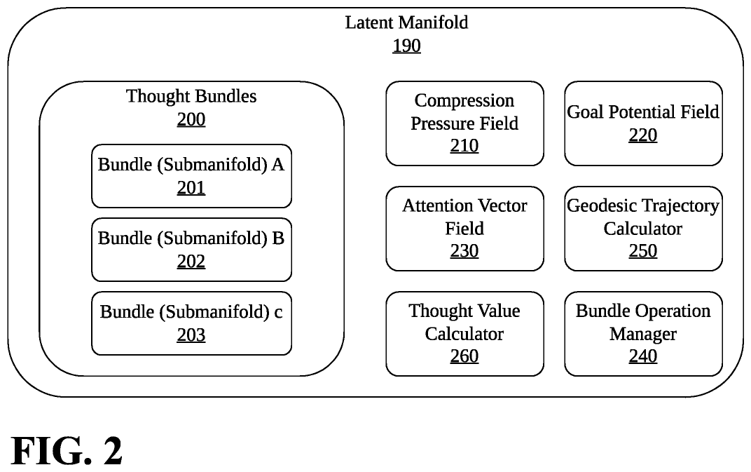

FIG. 2 is a block diagram illustrating an exemplary architecture of a component within a Persistent Cognitive Machine, a latent manifold. Latent manifold 190 serves as the central cognitive substrate of the PCM system, existing as a continuously evolving geometric space where all cognitive operations unfold. Unlike traditional flat embedding spaces, this manifold exhibits variable curvature, dynamic topology, and rich internal structure that emerges from the interplay of memory, compression, and goal-directed cognition. The manifold's geometry is not predetermined but rather shaped by cognitive activity, with frequently traversed regions developing distinct topological features, semantic neighborhoods forming through repeated association, and compression pressure creating a non-uniform landscape that guides efficient reasoning.

Within the manifold, thought bundles 200 represent the primary organizational structures for persistent cognitive content. These bundles are not simple clusters of related vectors but rather compact submanifolds with their own internal geometry and semantic coherence. Thought bundles 200 section contains exemplary bundle submanifolds: bundle (submanifold) A 201, bundle (submanifold) B 202, and bundle (submanifold) C 203, each representing a distinct region of semantic space with its own local metric structure. Bundle A 201 might represent a coherent concept such as “machine learning algorithms,” containing not just definitional information but also procedural knowledge, historical context, mathematical foundations, and connections to related concepts. The internal structure of bundle A 201 includes a local metric that defines distances between sub-concepts, principal directions corresponding to major semantic variations, and boundary conditions that determine how the bundle interfaces with surrounding manifold regions. Bundle B 202 could embody a different domain such as “quantum mechanics principles,” maintaining its own geometric structure while potentially sharing boundary regions with bundle A 201 where interdisciplinary concepts like quantum machine learning emerge. Bundle C 203 might represent more abstract or procedural knowledge, such as “problem-solving strategies,” with a flatter internal geometry that facilitates flexible application across domains.

A compression pressure field 210 represents a scalar field defined over the entire manifold, encoding the cognitive effort required to traverse different regions based on their semantic density and structural complexity. This field is computed from the local Ricci curvature according to, where is a Ricci scalar measuring how geodesics converge or diverge at each point. High compression pressure indicates regions where many semantic concepts have been compressed together through repeated use and abstraction, creating areas that are rich in meaning but require significant cognitive effort to navigate precisely. For example, the intersection between bundles A 201 and B 202 might exhibit extremely high compression pressure where concepts from machine learning and quantum mechanics have been repeatedly integrated, forming dense theoretical structures that encode sophisticated interdisciplinary insights. The compression pressure field 210 continuously evolves as new thoughts are added, existing structures are reinforced through use, and the dream manager performs offline reorganization to optimize the manifold's geometry.

A goal potential field 220 implements a complementary scalar field that attracts attention toward semantically relevant or task-aligned regions of the manifold. Unlike the compression pressure that resists traversal, the goal potential creates gradients that guide cognitive flow toward desired outcomes. This field is dynamically generated based on current objectives, user queries, learned value functions, and internal drives, creating a time-varying landscape that shapes how attention moves through the space. When processing a specific query, goal potential field 220 might create high-potential regions around relevant thought bundles while maintaining lower potentials in unrelated areas, effectively creating an energetic funnel that guides inference toward useful conclusions. The interplay between compression pressure and goal potential creates a rich dynamical landscape where attention flows along paths that balance semantic coherence (avoiding excessive pressure) with goal relevance (following potential gradients).

An attention vector field 230 represents the instantaneous flow of cognitive focus throughout the manifold, defined as. Let A(x, t) denote the attention vector field at point x∈M_{thought} and time t. This vector encodes both the direction and intensity of attentional flow through the manifold. The evolution of _{A} is governed by a field equation analogous to fluid dynamics:

$$\frac{\partial A}{\partial t} + {∇}_{A} A = - ∇ ( P - ϕ )$$

Here [symbol] is the temporal rate of change of attention, _{∇AA} is the convective derivative (attention moving along itself), and _{-∇}(_{P}−Φ) is the driving force of flow-combining compression pressure and goal potential. This equation captures the local evolution of attention under the influence of memory structure and cognitive drive.

Attention vector field 230 exhibits complex behaviors including laminar flow along well-established reasoning paths, turbulent regions where competing potentials create cognitive uncertainty, convergence zones where multiple lines of reasoning reach similar conclusions, and vortices around semantic attractors representing obsessive or recursive thought patterns. The field's evolution enables the system to maintain cognitive continuity while adaptively responding to changing goals and newly discovered information.

A geodesic trajectory calculator 250 computes optimal paths through the manifold by solving the variational problem of minimizing cognitive action. Let γ(t):[0,T]→Mₜ be a smooth curve in the cognitive manifold, representing the evolution of attention over time. We define the cognitive action functional:

$$S [ γ ] = {\int }_{0}^{T} ( {‖ \dot{γ} ( t ) ‖}^{2} + P ( γ ( t ) ) - Φ ( γ ( t ) ) ) dt ,$$

where ∥γ′(t)∥² represents the kinetic energy of cognitive motion, P(γ(t)) is the compression pressure field at γ(t), and Φ(γ(t)) is the cognitive potential, encoding goal relevance. The geodesic γ*(t) is defined as the path that minimizes γ*=arg min S[γ]. This formulation generalizes attention from instantaneous lookup to purposeful traversal. Attention becomes a consequence of structure and constraint: it flows along the most efficient path shaped by memory (via pressure) and intent (via potential).

The calculator implements numerical methods to handle the manifold's non-Euclidean geometry, accounting for curvature effects, parallel transport of semantic vectors, and the influence of nearby thought bundles on path selection. For instance, when reasoning from a concept in bundle A 201 to a goal state in bundle C 203, the geodesic trajectory calculator 250 might identify multiple viable paths: a direct route through high-pressure regions requiring intense cognitive effort, a longer path circumnavigating dense areas while maintaining semantic coherence, or a creative trajectory that leverages unexpected connections through bundle B 202. A thought value calculator 260 assesses the utility and relevance of thoughts within the current cognitive context, computing scalar values that inform caching decisions, retrieval priorities, and structural reorganization. This component evaluates thoughts based on multiple criteria including frequency of access, semantic centrality within bundles, contribution to successful reasoning paths, alignment with current and historical goals, and potential for generalization or transfer learning. Thought value calculator 260 works closely with the thermodynamic decay system, where thoughts with consistently low values gradually lose activation energy and may eventually be pruned from the manifold. Conversely, highly valued thoughts become anchors around which new structures crystallize, creating stable semantic neighborhoods that facilitate efficient reasoning.

A bundle operation manager 240 orchestrates the dynamic restructuring of thought bundles through three primary operations that reshape the manifold's topology. Fanning-in operations occur when peripheral thoughts or loosely associated concepts are drawn into existing bundles through repeated co-activation or semantic alignment, effectively increasing the bundle's density and internal coherence. This process involves adjusting the local metric to create stronger attractions, modifying bundle boundaries to encompass new members, and updating internal structure to maintain navigability. Fanning-out operations enable bundles to expand into new semantic territories when existing concepts are extended, elaborated, or applied in novel contexts. During fanning-out, bundle operation manager 240 creates new subregions within bundles, establishes tentative connections to unexplored manifold areas, and maintains structural stability while allowing for creative expansion. Rebinding operations represent the most sophisticated transformation, occurring when multiple bundles exhibit sufficient semantic overlap or functional similarity to warrant integration into higher-order structures. Bundle operation manager 240 performs rebinding by identifying intersection regions between bundles, computing optimal merge strategies that preserve essential structure, creating meta-bundles that abstract common patterns, and updating the global manifold topology to reflect new conceptual hierarchies.

These components work in concert to create a living geometric space where cognition unfolds as structured motion rather than discrete computation. Thought bundles 200 provide persistent semantic anchors, compression pressure field 210 and goal potential field 220 create a dynamic energy landscape, attention vector field 230 enables fluid cognitive flow, the geodesic trajectory calculator 250 determines optimal reasoning paths, thought value calculator 260 maintains cognitive efficiency, and bundle operation manager 240 ensures the manifold evolves to support increasingly sophisticated reasoning. Together, they implement a form of geometric intelligence where memory shapes space, attention follows structure, and learning reshapes the very terrain of thought.

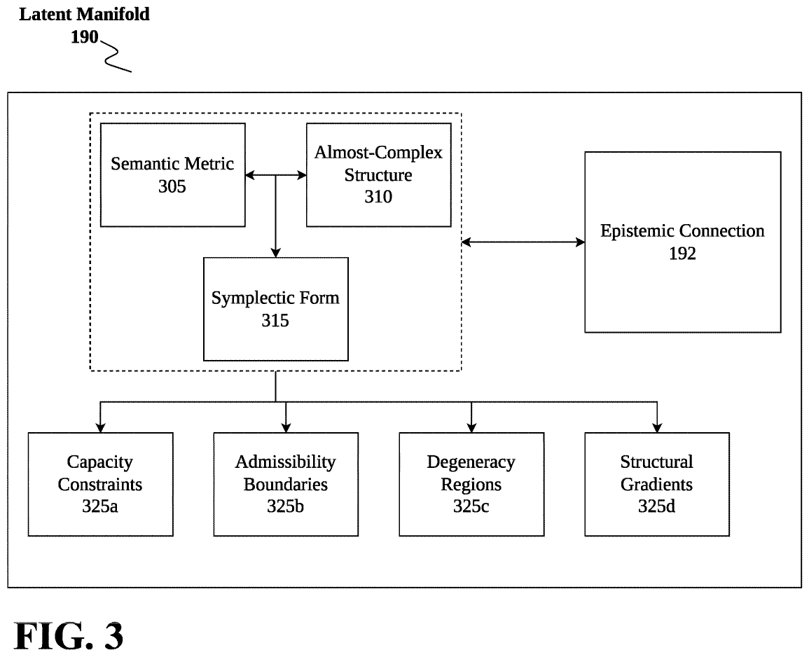

FIG. 3 is a block diagram illustrating exemplary architecture of an epistemically conditioned latent manifold, in an embodiment. Latent manifold 190 maintains four geometric data structures on a discrete simplicial complex G=(V, E, F) stored in memory and provides current geometric state to subsystems of a persistent cognitive system. Three sources supply updates to the geometric structures: an encoder subsystem contributes new vertices, edges, faces, interpolated J-structures, and edge phases arising from projection events; a manifold evolution and GPU execution subsystem contributes metric updates, J adjustments, and connection relaxation updates on separated timescales; and evidence-driven updates 301 contribute edge phase modifications to an epistemic connection as new evidence is incorporated into the system.

In an embodiment, a semantic metric 305 is represented by positive edge weights g_ij stored for edges of the simplicial complex, the weights encoding semantic dissimilarity between cognitive states represented as vertices. An almost-complex structure 310 is represented per vertex by a linear map J_i on an approximate tangent space, constrained such that J_i squared equals negative identity. The system enforces compatibility by constraining geometric updates so that deformations preserve, within tolerance, both semantic metric 305 and almost-complex structure 310. A J-Hermitian compatibility condition g(JX, JY)=g(X, Y) is maintained during metric updates by projecting updates onto a subspace satisfying the compatibility constraint.

A symplectic form 315 is reconstructed from semantic metric 305 and almost-complex structure 310 according to a compatibility relation ω(X, Y)=g(JX, Y). On the discrete complex, ω is evaluated on faces using edge vectors and local J assignments. Closedness dω=0 is verified and maintained within tolerance by enforcing discrete face-sum consistency conditions during update cycles. Together, semantic metric 305, almost-complex structure 310, and symplectic form 315 form an almost-Kähler-compatible triple maintained by processor-executed update routines, such that compatibility constraints are preserved during evolution of the manifold.

An epistemic connection 320 is implemented as a U(1) connection on an epistemic line bundle L over the manifold, assigning to each oriented edge a stored phase value u_ij=e\hat{ }{iθ_ij} encoding evidential consistency along that transition. A discrete epistemic curvature value F is computed on simplicial faces as a sum of edge phase values around each face. The curvature computation is independent of a Levi-Civita connection derived from semantic metric 305, enabling two regions identical under semantic metric 205 to exhibit different epistemic curvature values reflecting different levels of evidential support. Although epistemic connection 320 is geometrically independent of the almost-Kähler triple, it is operationally coupled to semantic metric 305, almost-complex structure 310, and symplectic form 315 through evolution dynamics, consolidation criteria, and hallucination diagnostics executed by other subsystems of persistent cognitive system.

The four geometric structures jointly establish epistemic conditioning of the manifold through four categories of computationally enforced constraint governing which cognitive operations may occur in which regions. Capacity constraints 325a are enforced by computing a local symplectic capacity from symplectic form 315 and deriving a capacity density as a ratio of local cognitive state count to computed symplectic capacity. When the capacity density exceeds a threshold, further insertion into the region is inhibited. In consolidated regions, compression routines are constrained so as not to reduce symplectic capacity below previously established levels, implementing a discrete analogue of a Gromov non-squeezing constraint through threshold enforcement rather than reliance on continuous deformation.

Admissibility boundaries 325b are implemented by computing reservoir barrier energy EOU at boundaries of consolidated regions, where the barrier energy integrates contributions from epistemic curvature magnitude |F|² derived from epistemic connection 320, extrinsic boundary curvature |K∂|² derived from semantic metric 305, and symplectic normal variation |dω_v|² derived from symplectic form 315. Barrier energy values are stored and compared against thresholds to determine whether transitions across boundary neighborhoods are permitted, thereby enforcing admissibility boundaries in discrete traversal routines.

Degeneracy regions 325c are identified when discrete epistemic curvature magnitude |F| computed from epistemic connection 320 exceeds a curvature threshold, indicating structural inconsistency or evidential strain. Regions exceeding the threshold are marked in memory as degeneracy regions, and traversal and consolidation routines consult these markings to inhibit reasoning operations or consolidation within those regions.

Structural gradients 325d are computed as a learning readiness field A (b) defined on reservoir boundaries. The learning readiness field is calculated from variation of almost-complex structure 310, symplectic form 315, and epistemic connection 320 in boundary neighborhoods, and quantifies energetic cost of extending a consolidated region in a given direction. Traversal and consolidation routines consult stored readiness values to bias growth and reasoning toward directions exhibiting lower computed extension cost, thereby implementing structural gradients as operational guidance rather than abstract geometric properties.

In an embodiment, capacity constraints 325a, admissibility boundaries 325b, degeneracy regions 325c, and structural gradients 325d are illustrative categories of epistemic conditioning implemented by latent manifold 190 and are not exhaustive. Additional geometric state descriptors may be defined and maintained in memory based on combinations or higher-order functions of semantic metric 305, almost-complex structure 310, symplectic form 315, epistemic connection 320, holonomy descriptors, topological invariants, or evolution dynamics. Such additional descriptors may include, without limitation, regions characterized by distinct holonomy class constraints, phase stability regimes, structural integrability levels derived from a Nijenhuis tensor magnitude, relaxation-gradient distributions, quantized curvature aggregates associated with discrete topological invariants, or other computed observables that influence admissibility evaluation, traversal biasing, consolidation gating, or suppression decisions. Any such geometric state may be represented as stored fields, flags, indices, or scalar or tensor quantities derived from underlying geometric structures and may participate in constraint enforcement through threshold comparison, routing logic, or update rules executed by one or more processors. Accordingly, epistemic conditioning of the manifold is not limited to the specific constraint categories illustrated in FIG. 3, but encompasses any geometric or topological state representation derived from maintained manifold structures and used to regulate formation, traversal, consolidation, or expression of reasoning trajectories.

Geometric state comprising semantic metric 305, almost-complex structure 310, symplectic form 315, and epistemic connection 320, together with constraint information derived from capacity constraints 325a, admissibility boundaries 325b, degeneracy regions 325c, and structural gradients 325d, is provided by latent manifold 190 to

In an embodiment, data flows through latent manifold substrate 190 on separated timescales reflecting different rates of geometric change. On a fast timescale, encoder supplies new vertices, edges, and faces that locally perturb semantic metric 305, together with interpolated J-structures incorporated into almost-complex structure 310 and edge phases incorporated into epistemic connection 320. After each perturbation, symplectic form 315 is reconstructed from updated semantic metric 305 and almost-complex structure 310 and discrete closedness conditions are re-verified.

On an intermediate timescale, a manifold evolution and GPU execution subsystem applies a compression flow that adjusts coordinates associated with semantic metric 305 and applies J adjustments that reduce a Nijenhuis tensor norm associated with almost-complex structure 310, thereby driving regions undergoing stabilization toward approximately Kähler-compatible configurations within computational tolerances.

On a slow timescale, manifold evolution and GPU execution subsystem applies a connection relaxation flow that reduces total squared discrete epistemic curvature of epistemic connection 320 through incremental phase updates, while evidence-driven updates modify individual edge phases in response to new input. As geometric structures evolve under these separated flows, constraint information derived from capacity constraints 325a, admissibility boundaries 325b, degeneracy regions 325c, and structural gradients 325d is recomputed and updated in memory. Updated geometric state is then provided to downstream subsystems for use in subsequent cycles of a gated pipeline of persistent cognitive system, ensuring that admissibility constraints reflect accumulated experience and evolving manifold structure.

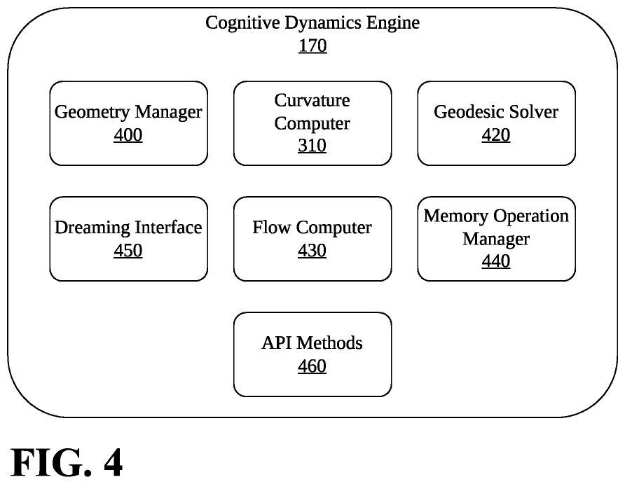

FIG. 4 is a block diagram illustrating an exemplary architecture of a component within a Persistent Cognitive Machine, a Cognitive Dynamics Engine (CDE). Operating as a specialized geometry processor analogous to a physics engine in simulation environments, CDE 170 manages the continuous shaping, traversal, and optimization of the cognitive manifold through coordinated geometric operations. This engine transforms the abstract principles of differential geometry and dynamical systems into practical computational mechanisms that enable persistent, adaptive cognition through structured space.

A geometry manager 400 serves as the component responsible for maintaining and evolving the manifold's geometric structure. Geometry manager 400 continuously tracks and updates the Riemannian metric tensor across all regions of the latent manifold, defining how distances, angles, and volumes are measured within the cognitive space. The metric is not static but evolves dynamically based on cognitive activity, with frequently traversed regions experiencing metric contraction that brings related concepts closer together, while unexplored areas maintain broader metric spacing that allows for flexible exploration. Geometry manager 400 also maintains the connection, which governs how vectors and tensors are parallel transported across the curved manifold. This connection evolves through use, with repeated attention trajectories establishing preferred directions of parallel transport that become the “natural” ways to move between concepts. For example, if reasoning paths frequently connect concepts from physics to machine learning applications, geometry manager 400 adjusts the connection to make these transitions smoother and more efficient. Geometry manager 400 implements algorithms for metric learning from trajectory data, using transition frequencies, co-activation patterns, and semantic alignment to continuously refine the geometric structure. It also manages coordinate transformations between different local charts of the manifold, ensuring smooth transitions as attention moves between semantic regions.

A curvature computer 410 calculates the various curvature tensors that characterize the manifold's local and global geometric properties. Curvature computer 410 computes a Riemann curvature tensor, which fully describes how the manifold deviates from flat Euclidean space. From this fundamental tensor, curvature computer 410 derives the Ricci tensor and the Ricci scalar, which measure how volumes contract or expand under geodesic flow. For cognitive dynamics, it computes the compression pressure field P(x)=−R(x), transforming geometric curvature into a cognitive cost function that governs attention flow. Curvature computer 410 employs multiple estimation strategies to handle the computational complexity of exact curvature calculation in high dimensions. These include geodesic deviation methods that track how nearby attention paths converge or diverge over time, Jacobian-based approximations using learned transition functions between manifold regions, and sampling techniques that estimate curvature from the statistical properties of local trajectory bundles. The component maintains a continuously updated curvature map across the manifold, identifying high-curvature regions where semantic compression has created dense knowledge structures, saddle points where conceptual boundaries meet, and flat regions suitable for creative exploration or interpolation. A geodesic solver 420 computes optimal paths through the manifold by solving the fundamental equation of cognitive motion. Given an initial state and a goal configuration, it determines the trajectory that minimizes the cognitive action function. This variational problem balances three competing factors: the kinetic energy that penalizes rapid changes in attention, the compression pressure that increases cost in semantically dense regions, and the goal potential that provides attractive forces toward relevant areas. Geodesic solver 420 implements sophisticated numerical methods adapted for manifold computation, including Riemannian gradient descent that respects the manifold's metric structure, shooting methods that propagate initial velocities forward while satisfying boundary conditions, and relaxation techniques that iteratively refine approximate paths toward true geodesics. The solver must handle multiple challenging scenarios such as non-convex optimization landscapes with multiple local minima, regions of high curvature where standard methods become unstable, and multi-goal situations requiring Pareto-optimal path selection. For instance, when solving a complex reasoning task that requires connecting disparate concepts, geodesic solver 420 might identify several viable paths: a direct route through high-pressure theoretical abstractions, a longer but clearer path through concrete examples, or an innovative trajectory that discovers unexpected connections through analogical reasoning.

A flow computer 430 models attention as a continuous vector field evolving over the manifold according to geometric dynamics. Rather than treating attention as discrete selections or weights, this component implements a partial differential equation, where attention behaves as a cognitive fluid flowing through shaped space. The flow computer 430 discretizes this equation using finite element methods adapted for manifolds, handling the complexities of curved space while maintaining numerical stability. It tracks how attention propagates through the manifold, creating flow patterns that include laminar streams along well-established reasoning paths, bifurcations where attention splits between competing hypotheses, convergence zones where multiple reasoning lines reach similar conclusions, and turbulent regions indicating cognitive uncertainty or conflicting goals. The component also computes derived quantities such as the divergence indicating where attention is focusing or dispersing, the curl revealing rotational patterns in thought, and flow stability metrics that identify robust versus fragile reasoning patterns. Flow computer 430 enables the system to maintain multiple concurrent attention streams, supporting parallel reasoning processes that can later merge or inform each other.

A memory operation manager 440 orchestrates structural modifications to thought bundles and manifold topology based on cognitive activity and optimization criteria. This component implements the three fundamental bundle operations that reshape semantic space. During fanning-in operations, it identifies loosely associated thoughts that show increasing co-activation and guides their consolidation into tighter bundle structures, adjusting local metrics to strengthen their mutual attraction, updating bundle boundaries to encompass new members, and recalculating internal bundle geometry to maintain efficient navigation. Fanning-out operations are triggered when existing bundles need to expand into new semantic territory, with memory operation manager 440 creating new submanifold regions, establishing tentative connections to unexplored areas, and maintaining structural stability during expansion. Rebinding operations occur when the manager detects sufficient overlap or functional similarity between bundles to warrant higher-order integration, executing merge algorithms that preserve essential structure while creating new abstractions. Memory operation manager 440 also handles subspace alignment for federated learning scenarios, enabling knowledge transfer between different PCM instances while respecting privacy boundaries.

A dreaming interface 450 provides the connection point between CDE 170 and dream manager 180, enabling autonomous manifold reorganization during off-task periods. This interface exposes methods for initiating various dreaming operations including targeted perturbation of specific manifold regions, global relaxation processes that smooth unnecessary complexity, and exploratory synthesis of new conceptual connections. Dreaming interface 450 manages the transition between active cognition and dreaming states, ensuring that ongoing reasoning processes reach stable states before reorganization begins, that critical structures are preserved during transformation, and that the manifold returns to a coherent state before resuming active operation. During dreaming phases, the interface coordinates bundle recombination algorithms that discover emergent abstractions, topology modification procedures that create new conceptual bridges, and compression operations that consolidate redundant structures. It monitors dreaming progress through geometric health metrics, ensuring that reorganization improves rather than disrupts cognitive capability.

An API methods 460 component provides a clean programmatic interface for external modules to interact with the CDE's geometric capabilities. API methods may include accepting a goal embedding and current state to return an optimal geodesic path, leveraging the geodesic solver while accounting for current manifold conditions. Updating reinforces the manifold along a recently traversed path, strengthening the metric connections and potentially triggering bundle formation. Querying a bundle identifies the nearest thought bundle to a given manifold point, using both geometric proximity and semantic alignment. Dreaming initiates autonomous reorganization procedures through the dreaming interface. Getting pressure returns the compression pressure at any point, enabling other components to make informed decisions about traversal costs. Getting a goal field constructs a potential field for a given goal configuration, coordinating with the goal manager to shape attention flow. These methods abstract away the complex geometric computations while providing powerful primitives for cognitive operations. API methods 460 also handles request queuing, resource management, and error handling to ensure robust operation under varying computational loads.

Together, these components within cognitive dynamics engine 170 create a geometric substrate for persistent cognition. Geometry manager 400 maintains the foundational structure, curvature computer 410 derives the pressure landscape that guides efficient reasoning, geodesic solver 420 finds optimal paths through semantic space, flow computer 430 enables fluid attention dynamics, memory operation manager 440 evolves the manifold through use, dreaming interface 450 enables autonomous optimization, and API methods 460 provide clean access to these capabilities. This architecture transforms the principles of geometric cognition into a practical computational system where thought truly becomes motion through shaped space, memory becomes curvature, and learning becomes the evolution of geometry itself.

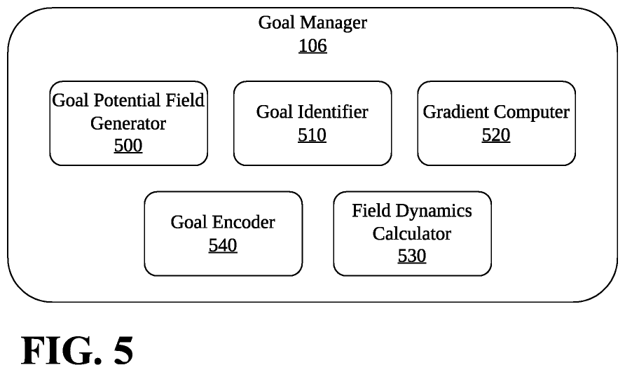

FIG. 5 is a block diagram illustrating an exemplary architecture of a component within a Persistent Cognitive Machine, a goal manager. Unlike traditional goal-directed systems that implement objectives as discrete targets or symbolic constraints, goal manager 120 generates continuous scalar fields that attract attention and guide reasoning through geometric influence. This component transforms abstract intentions, user queries, and system objectives into structured force fields that interact with the manifold's compression landscape to create rich cognitive dynamics.

A goal identifier 510 serves as the initial processing stage that recognizes, categorizes, and prioritizes various goal sources entering the system. Goal identifier 510 processes inputs from multiple channels including explicit user queries that directly state objectives or ask questions, implicit user patterns derived from interaction history and preferences, system-generated goals arising from internal drives such as uncertainty reduction or consistency maintenance, and task constraints imposed by external requirements or operational parameters. Goal identifier 510 implements parsing algorithms that go beyond keyword extraction to understand the semantic intent behind goals. When processing a user query such as “How can we apply quantum computing principles to optimize machine learning algorithms?”, the component identifies multiple nested goals: understanding quantum computing principles, comprehending optimization in machine learning, finding intersection points between these domains, and generating practical applications. Goal identifier 510 also performs goal decomposition, breaking complex objectives into hierarchical subgoals that can be pursued in parallel or sequence. It maintains a goal registry that tracks active objectives, their priorities, interdependencies, and completion states. The component implements conflict detection mechanisms that identify when multiple goals may be contradictory or competing for the same cognitive resources, flagging these for special handling by other components. For long-term interactions, goal identifier 610 maintains persistent goal structures that evolve across sessions, enabling the system to pursue complex objectives that require extended reasoning or multiple interaction cycles.

A goal encoder 540 transforms identified goals from their raw representational form into geometric structures compatible with the manifold's architecture. This encoding process goes beyond simple embedding, creating rich geometric objects that can effectively influence manifold dynamics. Goal encoder 540 implements multiple encoding strategies tailored to different goal types. For similarity-based goals, it computes embedding vectors and defines potential fields, creating gradients that attract attention toward semantically similar regions. For constraint-based goals, it generates potential fields with low values in prohibited regions and high values in acceptable areas, effectively creating barriers and channels that guide reasoning. Goal encoder 540 also implements contrastive encoding for goals that require distinguishing between concepts, creating potential fields with opposing gradients that push attention away from certain regions while pulling toward others. For complex multi-faceted goals, goal encoder 540 generates composite fields that superimpose multiple potential patterns, creating rich landscapes with multiple attractors, saddle points, and gradient flows. The encoding process considers the current state of the manifold, adapting the potential field to work effectively with existing compression patterns and thought structures. For instance, when encoding a goal related to creative problem-solving, the component might generate a potential field with multiple local maxima in different semantic regions, encouraging exploration of diverse solution approaches rather than convergence on a single path.

A goal potential field generator 500 takes encoded goals and constructs the complete scalar field across the entire manifold. This component implements field generation algorithms that create smooth, differentiable potential landscapes while respecting the manifold's geometric constraints. The generator computes field values at each point by considering multiple factors including semantic distance from goal representations, alignment with goal constraints and requirements, historical success rates for similar goals in nearby regions, and interaction effects between multiple concurrent goals. Goal potential field generator 500 employs kernel methods to create smooth field variations, preventing discontinuities that could destabilize attention flow. It implements field normalization procedures to ensure that potential values remain within reasonable ranges across the manifold, preventing any single goal from completely dominating cognitive dynamics. Goal potential field generator 500 also generates time-varying fields for goals that evolve during reasoning, smoothly interpolating between different field configurations to maintain continuity. For hierarchical goals, it creates nested potential structures where achieving subgoals creates local maxima within the broader landscape of the primary objective. The generator must balance field strength to create sufficient attractive force without overwhelming the natural dynamics of compression and manifold structure. For example, when generating a field for a goal requiring innovative connections between disparate concepts, the component might create a potential landscape with a valley between the concepts that gradually rises, encouraging exploration of the intermediate space where novel connections might emerge.

A gradient computer 520 calculates the vector field that determines the direction and magnitude of goal-induced forces at each point in the manifold. This component implements efficient algorithms for computing gradients in curved space, accounting for the manifold's metric structure to ensure that gradients represent true geometric directions rather than naive coordinate derivatives. Gradient computer 520 employs multiple computational strategies including finite difference methods adapted for manifolds, automatic differentiation through the field generation process, and analytical gradients for simple field configurations. It computes not only first-order gradients but also higher-order derivatives such as the Hessian, which indicates the local curvature of the potential field and helps identify critical points such as maxima, minima, and saddle points. The component maintains a continuously updated gradient map across frequently accessed regions of the manifold, enabling rapid attention flow calculations without repeated gradient computation. For regions of high curvature or complex metric structure, gradient computer 520 implements adaptive sampling strategies that ensure accurate gradient estimation despite geometric complications. It also computes gradient statistics such as divergence and curl, providing insights into the global flow patterns induced by the goal field. These computations enable analyses of goal dynamics, identifying convergence regions where attention naturally flows, circulation patterns that might indicate conceptual loops, and divergence zones where exploratory behavior is encouraged.

A field dynamics calculator 530 analyzes and predicts the complex behaviors that emerge from the interaction between goal potential fields and the manifold's other forces. This component simulates how attention will flow under the combined influence of goal attraction, compression resistance, and the inherent dynamics of the attention field itself. Field dynamics calculator 530 implements several analytical capabilities including trajectory prediction that estimates likely attention paths given current conditions, stability analysis that identifies whether goal configurations will lead to stable focus or oscillatory behavior, and bifurcation detection that recognizes when small changes in goals might lead to dramatically different cognitive outcomes. The component models various emergent phenomena such as gradient following where attention flows smoothly up potential gradients toward goal regions, tunneling effects where strong goal potentials can overcome high compression barriers, and competitive dynamics where multiple goals create complex flow patterns with unpredictable outcomes. For multi-goal scenarios, field dynamics calculator 530 computes Pareto frontiers that identify optimal trade-offs between competing objectives, helping the system navigate complex decision spaces. It also analyzes temporal dynamics, predicting how goal influences will evolve as the manifold structure changes through use and learning. The component can identify potential failure modes such as local maxima that might trap attention before reaching true goals, unstable equilibria where small perturbations cause large behavioral changes, and chaotic regions where goal interactions create unpredictable dynamics. For instance, when analyzing goals that require balancing exploration with exploitation, field dynamics calculator 530 might identify parameter regimes where the system naturally alternates between focused pursuit and broad exploration, optimizing long-term learning and performance.

The components within goal manager 106 create a system for translating abstract objectives into concrete geometric influences that shape cognitive behavior. Goal identifier 510 recognizes and structures incoming objectives, goal encoder 540 transforms them into geometric representations, goal potential field generator 500 creates smooth scalar fields across the manifold, gradient computer 520 determines the resulting force fields, and field dynamics calculator 530 predicts and analyzes the emergent behaviors. This architecture enables the PCM to pursue complex goals not through rigid programming or symbolic planning, but through the natural dynamics of attention flowing through shaped space. Goals become not commands to be executed but influences that guide the fluid motion of thought, creating a form of intentionality that emerges from geometry rather than being imposed upon it. Goal manager 106 thus provides the motivational landscape that, combined with the manifold's memory structure and compression dynamics, enables purposeful yet flexible cognitive behavior that can adapt, learn, and discover unexpected solutions through the natural evolution of geometric attention.

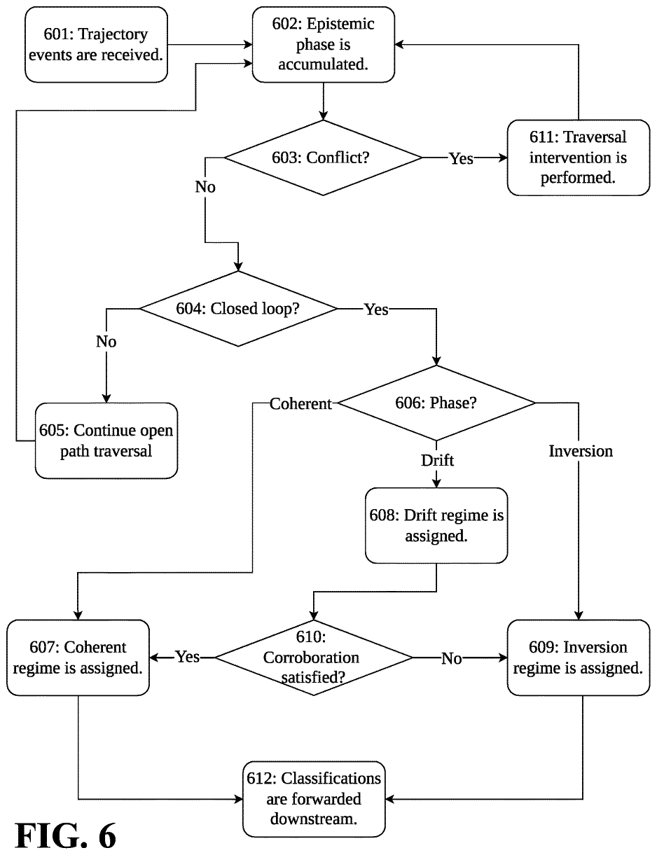

FIG. 6 is a flow diagram illustrating exemplary holonomy and epistemic phase monitoring within an epistemically conditioned persistent cognitive system, in an embodiment. A holonomy and epistemic phase monitoring subsystem receives trajectory events from a traversal and reasoning subsystem, the trajectory events comprising edge traversals, position updates, and contextual information associated with an active cognitive trajectory, the events being represented as updates to traversal data structures maintained in memory including a current vertex identifier, a visited-vertex index, and an accumulated phase variable 601. Holonomy and epistemic phase monitoring subsystem computes and updates a stored epistemic phase variable Φ along the active trajectory by summing scalar phase values θ assigned by epistemic connection 192 of latent manifold 190 to each edge traversed, the scalar summation being performed over stored edge phase values associated with oriented edges of a discrete cognitive graph, the accumulated phase representing total evidential drift along the reasoning path 602.

Holonomy and epistemic phase monitoring subsystem computes one or more discontinuity metrics to determine whether a phase discontinuity or a conflict among holonomy descriptors applicable to a current traversal location exists, the discontinuity metrics including comparison of incremental phase gradient against a stored gradient threshold, evaluation of compatibility residuals between transported holonomy descriptors exceeding a descriptor conflict threshold, detection of traversal across a homotopy class identifier previously marked as suppressed in a constraint index, or detection of partial loop structures whose accumulated phase magnitude exceeds a bounded pre-closure threshold prior to loop completion 603. When no phase discontinuity metric exceeds its corresponding threshold and no holonomy conflict condition is satisfied, holonomy and epistemic phase monitoring subsystem evaluates whether the active trajectory has revisited a previously visited vertex as determined by a lookup in a visited-vertex hash table maintained in memory, thereby detecting formation of a closed loop 604. When no closed loop is detected, holonomy and epistemic phase monitoring subsystem continues open-path traversal monitoring by maintaining the accumulated phase variable and returns to accumulating epistemic phase along subsequent edges of the active trajectory 605.

When a closed loop γ is detected, holonomy and epistemic phase monitoring subsystem computes a loop-specific epistemic phase Φ(γ) by summing stored edge phase values along the detected loop and classifies the loop into a phase regime by comparing an absolute value of Φ(γ) to a phase drift threshold Φ* and to π, the classification being recorded in a trajectory state structure 606. When the magnitude of Φ(γ) is at or below the phase drift threshold Φ*, holonomy and epistemic phase monitoring subsystem assigns a coherent regime classification indicating that the reasoning loop maintained evidential coherence within tolerance and that consolidation of conclusions drawn along the loop is permitted 607. When the magnitude of Φ(γ) exceeds the phase drift threshold Φ* but remains below π, holonomy and epistemic phase monitoring subsystem assigns a drift regime classification indicating that the loop accumulated significant epistemic drift and that consolidation is deferred pending corroboration by an independent path 608. When the magnitude of Φ(γ) equals or exceeds π, holonomy and epistemic phase monitoring subsystem assigns an inversion regime classification indicating that evidential grounding at the conclusion is misaligned with grounding at the start beyond an inversion threshold, that consolidation is blocked, and that the trajectory is marked for subsequent irreversible suppression by consolidation and irreversible suppression subsystem through setting of a suppression flag in a trajectory control structure 609.

For a trajectory classified in the drift regime, holonomy and epistemic phase monitoring subsystem evaluates whether an independent corroborating path γ′ supplied by traversal and reasoning subsystem satisfies three computationally verifiable conditions: γ′ terminates at a cognitive state whose geodesic distance under semantic metric g is within a proximity threshold of the conclusion reached by the original trajectory; γ′ maintains accumulated epistemic phase within the coherent regime as determined by comparison against phase drift threshold Φ*; and γ′ is not deformable into the original trajectory within the reservoir-stratified state space as determined by comparison of homotopy class identifiers or by evaluating reachability equivalence under barrier edge constraints supplied by consolidation and irreversible suppression subsystem.

When a phase discontinuity metric exceeds its threshold or a holonomy conflict condition is detected at step 603, holonomy and epistemic phase monitoring subsystem modifies traversal control structures of traversal and reasoning subsystem during reasoning execution, the modification comprising at least one of terminating a traversal stack entry, re-routing traversal through an alternative admissible edge selected from a priority queue excluding edges associated with suppressed homotopy classes or degeneracy regions, performing controlled backtracking to a previously recorded coherent vertex, suspending traversal pending additional input, or marking the trajectory for subsequent irreversible suppression, and after such intervention the redirected or resumed trajectory returns to epistemic phase accumulation with the accumulated phase variable updated in accordance with the modified traversal state 611.

Holonomy and epistemic phase monitoring subsystem forwards phase regime classifications comprising coherent, drift, or inversion designations together with curvature type decomposition into J-invariant and J-anti-invariant components computed from discrete epistemic curvature values associated with faces traversed by the trajectory to consolidation and irreversible suppression subsystem, the forwarded data being used for boundary event classification, consolidation gating, and generation of abstract constraint representations for non-invertible projection 612.

### Description of Method Aspects

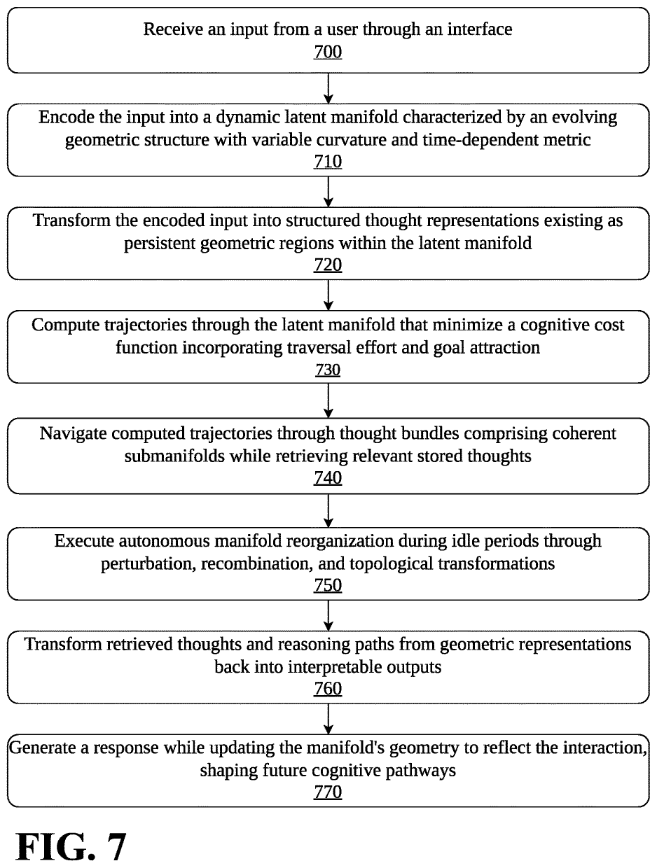

FIG. 7 is a flow diagram illustrating an exemplary method for implementing persistent cognitive computation through geometric representation and manipulation of thoughts within a dynamic latent manifold. In a first step 700, receive an input from a user through an interface. This initial step establishes the entry point for external information into the cognitive process, where inputs may comprise natural language queries, multimodal data streams, commands, or any form of structured or unstructured information requiring cognitive processing. The interface serves as a bidirectional communication channel that not only receives inputs but maintains context from previous interactions, enabling coherent long-term dialogues where each new input can build upon established semantic foundations encoded within the geometric substrate.

In a step 710, encode the input into a dynamic latent manifold characterized by an evolving geometric structure with variable curvature and time-dependent metric. This encoding process transforms raw external data into geometric representations within a high-dimensional space where semantic relationships are captured through curvature, distance, and topological features rather than static vector embeddings. The latent manifold operates as a living geometric substrate with a Riemannian or pseudo-Riemannian metric tensor that evolves based on usage patterns, wherein frequently accessed semantic regions develop distinct curvature characteristics that facilitate efficient navigation. The encoding respects existing manifold structure, placing new inputs in regions that maintain semantic coherence with previously encoded information while allowing the manifold itself to deform and adapt to accommodate novel concepts. This dynamic encoding ensures that the same input may be mapped to slightly different manifold locations at different times, reflecting the evolving understanding and context within the cognitive system.

In a step 720, transform the encoded input into structured thought representations existing as persistent geometric regions within the latent manifold. Thoughts, as discrete units of reasoning or analysis generated during processing, are not mere points in space but extended geometric structures that may manifest as compact submanifolds, trajectories, or complex topological features. This transformation involves processing the encoded input through sophisticated algorithms that identify semantic components, establish relationships between concepts, and construct high-dimensional representations that capture not only explicit content but implicit contextual meanings and potential inferential pathways. The resulting thought structures exhibit internal geometry that reflects their semantic complexity, with simple atomic thoughts occupying relatively flat regions while complex structured thoughts may exhibit significant curvature and multi-dimensional extent. These thought representations become persistent features of the manifold, subject to future retrieval, recombination, and evolution through continued cognitive activity.

In a step 730, compute trajectories through the latent manifold that minimize a cognitive cost function incorporating traversal effort and goal attraction. This computation implements geodesic attention, where focus or inference is achieved by computing minimal-energy paths through the manifold rather than discrete selection operations. The cognitive cost function balances multiple factors including kinetic energy that penalizes rapid shifts in attention, compression pressure derived from local semantic density that makes traversal through highly compressed regions more costly, and goal potential fields that create attractive forces toward relevant semantic areas. The trajectory computation employs variational principles to find paths that optimize this multi-factor cost function, resulting in smooth, continuous reasoning paths that respect the manifold's geometry while efficiently pursuing cognitive objectives. These trajectories may branch, merge, or exhibit complex topology depending on the interplay between manifold structure and goal requirements, enabling rich inferential patterns that go beyond linear reasoning chains.

In a step 740, navigate computed trajectories through thought bundles comprising coherent submanifolds while retrieving relevant stored thoughts. Navigation involves traversing the computed paths while interacting with latent subspaces or thought bundles-localized, compressible regions containing structurally similar or semantically aligned thoughts. As trajectories pass through or near these bundles, relevant thoughts are activated and retrieved based on geometric proximity, semantic alignment, and contextual appropriateness. The navigation process respects bundle boundaries and internal structure, potentially following established paths within bundles that represent well-learned reasoning patterns or exploring novel connections between previously unrelated bundles. Retrieved thoughts contribute to the ongoing cognitive process, providing historical context, learned patterns, and relevant knowledge that enriches the current reasoning trajectory. This navigation implements a form of associative memory where retrieval is not based on exact matching but on geometric traversal through semantically organized space.

In a step 750, execute autonomous manifold reorganization during idle periods through perturbation, recombination, and topological transformations. This dreaming process operates as a background mechanism for structural optimization and generalization discovery. Perturbation involves applying controlled stochastic variations to existing thought structures to test their stability and explore nearby semantic spaces. Recombination implements sophisticated interpolation and integration algorithms that synthesize new abstractions from existing thoughts, potentially discovering emergent patterns or generalizations not explicitly present in the original structures. Topological transformations may alter the fundamental connectivity of the manifold, creating new bridges between previously disconnected regions or splitting overly complex areas into more manageable components. These reorganization operations improve manifold efficiency, reduce redundancy, and enhance the system's capacity for creative inference and generalization, all while maintaining semantic coherence and preserving valuable learned structures.

In a step 760, transform retrieved thoughts and reasoning paths from geometric representations back into interpretable outputs. This decoding process must interpret rich geometric information including positions within the manifold, traversed trajectories, local curvature contexts, and relationships between activated thought bundles. The transformation preserves not just the conclusions reached but the reasoning process itself, enabling explanatory outputs that reflect the structured path taken through semantic space. Decoding accounts for the multi-dimensional nature of thoughts, potentially generating outputs that capture nuanced relationships, conditional dependencies, and contextual qualifications that emerge from the geometric reasoning process. The decoded information maintains coherence with the original query while potentially introducing insights or connections discovered through manifold traversal that were not explicitly present in the input.

In a step 770, generate a response while updating the manifold's geometry to reflect the interaction, shaping future cognitive pathways. Response generation synthesizes the decoded thoughts and reasoning paths into appropriate output formats while simultaneously modifying the underlying geometric substrate based on the completed cognitive cycle. Manifold updates may include but are not limited to strengthening frequently traversed paths through metric adjustment, increasing curvature around newly important semantic regions, establishing new connections between previously unrelated thoughts, and adjusting bundle boundaries to reflect evolved understanding. These geometric modifications ensure that future cognitive operations benefit from accumulated experience, with successful reasoning patterns becoming easier to traverse while maintaining flexibility for novel exploration. The bidirectional process of response generation and manifold update implements a form of continuous learning where each interaction contributes to the long-term evolution of the cognitive substrate, creating an increasingly sophisticated geometric landscape that embodies accumulated knowledge, learned patterns, and refined reasoning capabilities.

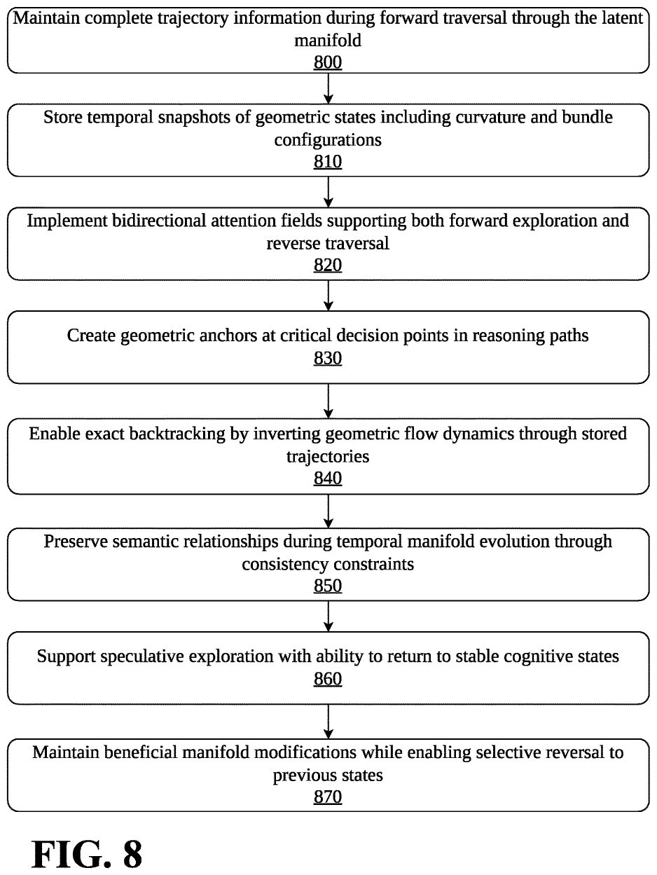

FIG. 8 is a flow diagram illustrating an exemplary method for implementing reversible navigation within dynamic latent manifolds. In a first step 800, maintain complete trajectory information during forward traversal through the latent manifold. This maintenance process creates a comprehensive record of the cognitive path taken, capturing not just the sequence of positions visited but the full geometric context of the traversal. The trajectory information includes but is not limited to the precise coordinates of each point along the path, the velocity and acceleration of attention movement, local curvature values and metric tensor components at each position, and the compression pressure and goal potential fields encountered. This detailed recording enables faithful reconstruction of the cognitive journey, preserving information about why specific paths were chosen, how attention flowed through different regions, what semantic relationships were activated, and which thought bundles were engaged during reasoning. The maintenance mechanism operates continuously during active cognition, creating a rich trace that serves as both a record of reasoning and a foundation for potential backtracking.

In a step 810, store temporal snapshots of geometric states including curvature and bundle configurations. These snapshots capture the complete state of relevant manifold regions at specific time points, creating a temporal sequence that documents how the cognitive landscape evolves during reasoning. Each snapshot preserves local and global curvature patterns reflecting semantic density and relationships, thought bundle boundaries and internal structures, metric tensor values defining distance relationships, active attention fields and their flow patterns, and compression pressure distributions across the manifold. The storage mechanism implements efficient compression techniques that preserve essential geometric information while managing memory requirements through identification of state changes requiring full snapshots, incremental storage of modifications between snapshots, and hierarchical representation enabling multi-resolution retrieval. These temporal snapshots enable not just backtracking through a static landscape but navigation to previous manifold configurations even as the underlying structure continues to evolve.

In a step 820, implement bidirectional attention fields supporting both forward exploration and reverse traversal. The attention vector field is enhanced to include reverse flow components that enable backward navigation along previously traversed paths. This bidirectional implementation maintains dual flow potentials at each manifold point, with forward components guided by goal attraction and exploration drives, and reverse components following stored trajectory gradients back toward previous positions. The field dynamics incorporate memory of past traversals, creating preferential flow channels along well-traveled paths while maintaining flexibility for deviation. The bidirectional nature enables smooth transitions between forward and backward navigation, supporting cognitive operations such as retracing steps to reconsider alternatives, returning to decision points for different choices, and comparing forward predictions with backward reconstructions. The implementation ensures that reverse traversal respects the evolved manifold geometry rather than simply replaying stored coordinates.

In a step 830, create geometric anchors at various decision points in reasoning paths. These anchors mark significant locations in the cognitive journey where important choices were made, multiple paths diverged, or key insights emerged. Anchor creation identifies points through analysis of trajectory bifurcations indicating choice points, local extrema in goal potential suggesting achievement milestones, curvature anomalies marking conceptual transitions, and high compression pressure regions requiring significant cognitive effort. Each anchor stores comprehensive local state information including the complete geometric configuration, available path options and their initial directions, decision criteria and goal states active at that point, and semantic context explaining the significance of the location. These anchors serve as cognitive waypoints that enable efficient navigation to important reasoning states without requiring full trajectory replay, supporting operations like returning to reconsider major decisions or comparing outcomes from different choice branches.

In a step 840, enable exact backtracking by inverting geometric flow dynamics through stored trajectories. This inversion process reverses the mathematical operations that generated forward motion, creating precise backward paths through the evolved manifold. The flow inversion accounts for the original geodesic equations by reversing time parameters, the influence of compression pressure and goal fields by negating their gradients, the effects of manifold evolution by applying inverse transformations, and the accumulation of path-dependent modifications. The backtracking mechanism enables exact retracing even through complex geometric regions including high-curvature zones where forward paths strongly converged, bifurcation regions where choices were made, and dynamically evolved areas where the manifold has changed. This precise reversal capability ensures that cognitive exploration can be truly reversible, enabling confident speculation knowing that return to stable states is guaranteed.

In a step 850, preserve semantic relationships during temporal manifold evolution through consistency constraints. As the manifold evolves through use and learning, this preservation mechanism ensures that semantic meanings remain stable enough to support meaningful backtracking. Consistency constraints maintain topological relationships between thought bundles, relative distance orderings between related concepts, essential curvature patterns that define semantic regions, and geodesic connections between ideas. The preservation process implements sophisticated transformation tracking that records how manifold regions evolve over time, applies compensating adjustments during backtracking to account for evolution, and maintains semantic anchors that provide stable reference points. This enables navigation to previous cognitive states even when the underlying geometry has been modified by intervening learning and adaptation, ensuring that backtracking arrives at semantically equivalent rather than merely geometrically identical states.

In a step 860, support speculative exploration with ability to return to stable cognitive states. This capability enables bold cognitive ventures into uncertain or potentially unstable regions while maintaining safety through guaranteed return paths. Speculative exploration is facilitated through creation of temporary manifold branches for experimental reasoning, suspension of normal stability constraints during exploration, monitoring of cognitive health metrics during speculation, and automatic triggering of return navigation if instability is detected.

The return mechanism provides rapid retreat to the nearest stable anchor point, gradual unwinding of speculative modifications, and preservation of valuable discoveries while discarding unstable structures. This creates a cognitive sandbox where novel connections can be explored, unconventional reasoning paths can be tested, and creative insights can emerge, all while maintaining the security of proven stable states.

In a step 870, maintain beneficial manifold modifications while enabling selective reversal to previous states. This final step implements intelligent preservation of positive changes discovered during exploration while still enabling return to earlier configurations. The selective reversal mechanism analyzes modifications made during forward traversal to identify beneficial changes such as new connections that improve reasoning efficiency, compressed representations that reduce cognitive load, discovered shortcuts between previously distant concepts, and refined curvature patterns that better capture semantic relationships. During reversal operations, the method preserves these beneficial modifications by maintaining them as overlays on reversed base geometry, creating parallel path options that include improvements, and marking enhanced regions for integration into the stable manifold. This selective approach ensures that the cognitive system continuously improves through exploration while maintaining the ability to recover from unsuccessful ventures, creating an optimal balance between stability and adaptability in the evolving geometric substrate of thought.

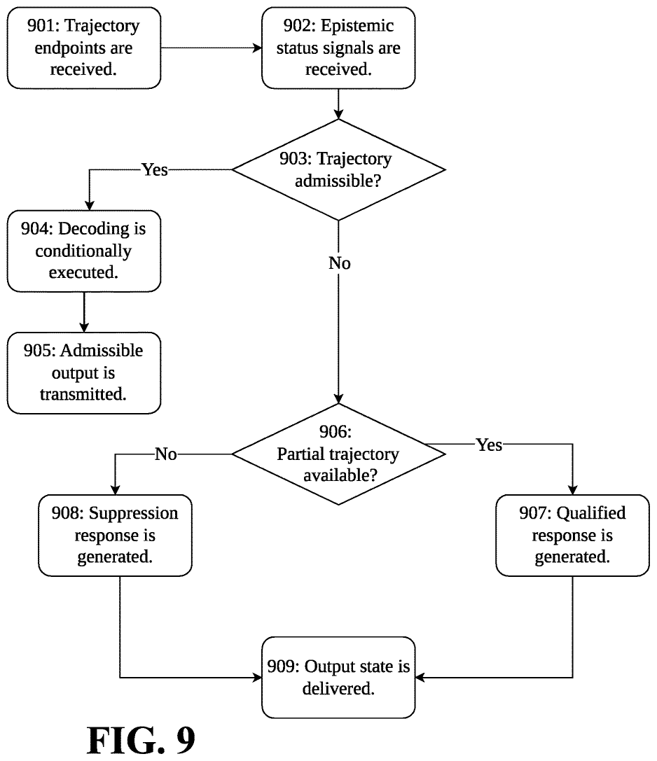

FIG. 9 is a flow diagram illustrating exemplary output generation and expression control within a trajectory-governed reasoning control system, in an embodiment. Output gating manager 120 receives completed trajectory endpoints from traversal subsystem 172, the endpoints being represented as trajectory identifiers and associated terminal cognitive state data stored in memory 901. Output gating manager 120 receives epistemic status signals comprising stored phase regime classifications from phase monitor 112 and loop classifier 114, consolidation gate decision flags from consolidation 116, and admission outcome flags from encoder 150, the signals being maintained as discrete status indicators associated with the completed trajectory 902. Output gating manager 120 computes a final admissibility determination for the completed trajectory by evaluating a logical conjunction of stored status indicators, wherein admissibility requires an absorb outcome at admission, a coherent or corroborated phase regime classification during traversal, and a true consolidation gate flag, and the logical conjunction result is stored as an output eligibility flag 903.

When the output eligibility flag indicates that the trajectory remains epistemically admissible, output gating manager 120 executes a manifold-conditioned decoding routine through decoder 130 that maps admissible cognitive states or trajectory results into external representations such as natural language responses, symbolic structures, or executable actions, wherein invocation of the decoding routine is conditioned on the output eligibility flag and decoder-level mechanisms including language models or generation heuristics are executed only when the output eligibility flag is true and are prevented from emitting output when the flag is false 904. Output gating manager 120 transmits the decoded representation corresponding to the admissible trajectory through output generator 140 to user interface 102 as system output 905.

When the output eligibility flag indicates that the trajectory does not remain epistemically admissible, output gating manager 120 evaluates whether a stored admissible prefix of the trajectory exists, the prefix corresponding to a portion of the trajectory that maintained coherent or corroborated phase regime status prior to detection of incoherence and being identified using stored phase regime transition points or discontinuity markers 906. When a stored admissible prefix is available, output gating manager 120 generates a qualified or partial response derived solely from cognitive states associated with the admissible prefix, and includes in the response structured indications of epistemic insufficiency corresponding to stored degeneracy region markers, high-curvature regions, barrier boundary encounters, or phase discontinuity locations encountered during traversal 907. When no admissible prefix is available, output gating manager 120 suppresses invocation of the decoding routine and instead generates a suppression response selected from a predefined set including withholding a response, requesting clarification or additional input, or deferring response to a later time or external process, and no decoded content derived from an epistemically inadmissible trajectory is emitted 908. Output gating manager 120 delivers the suppression or qualified response outcome through output generator 140 to user interface 102 as a valid system output state, wherein suppression is implemented as a defined architectural state rather than as an error condition 909.

### Hardware Architecture

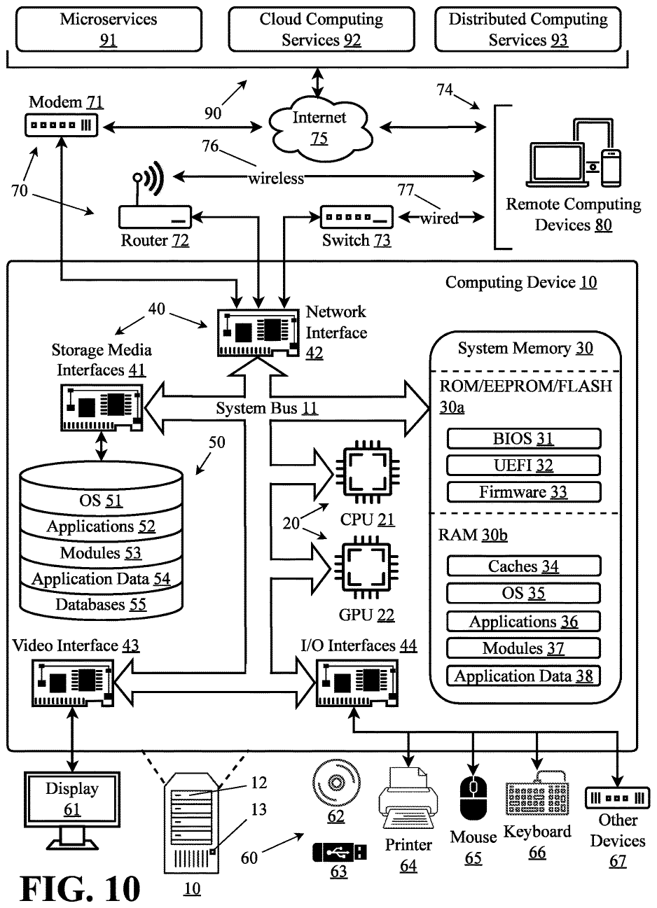

FIG. 10 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IOT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Container provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Federated distributed computing services 93 provide large-scale processing using multiple interconnected computers or nodes to solve computational problems or perform tasks collectively. In federated distributed computing, the processing and storage capabilities of multiple machines are leveraged to work together as a unified system, even when different tiers or tessellations may have limited or even no visibility into the resources and processing layer up or downstream. Federated distributed computing services are designed to address problems that cannot be efficiently solved by a single computer or that require large-scale computational power and require dynamism and workload distribution for economic, security or privacy reasons not well supported by canonical distributed computing resources; e.g. most commonly cloud-based computing applications, resources or analytics. Federated DCG coordinated variants of these services enable superior decentralization and further enhance parallel processing, fault tolerance, and scalability by distributing tasks across multiple tiers or tessellations while enabling computing process dependency calculation with varying degrees of visibility, assurance and privacy or security based on constituent computing system, network, workload and user or provider needs and preferences as well as practical legal and regulatory concerns to include but not limited to data localization, national data transfer restrictions, privacy and consumer protections, wiretap/telecommunications monitoring requirements, encryption and data routing and intermediate processing restrictions.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
maintain a latent manifold as a geometric substrate for cognitive operations, wherein the latent manifold encodes semantic relationships between cognitive states through a semantic metric and additionally maintains an epistemic connection that assigns transition-specific phase values to edges connecting cognitive states independently of the semantic metric;
compute geodesic trajectories through the latent manifold via a cognitive dynamics engine that minimizes a cognitive cost function incorporating traversal effort, compression pressure, and goal attraction;
during traversal of a computed trajectory, accumulate an epistemic phase quantity along the trajectory by summing phase values assigned by the epistemic connection to each edge traversed;
detect coherence failure conditions during traversal comprising at least one of phase drift beyond a threshold, a phase discontinuity, or a conflict among path-dependent descriptors applicable to a traversal location;
upon detection of a closed reasoning loop, classify the loop into a phase regime based on magnitude of the accumulated epistemic phase, the phase regimes comprising a coherent regime in which consolidation is permitted, a drift regime in which consolidation is deferred pending corroboration, and an inversion regime in which consolidation is blocked;
in response to detected coherence failure conditions or inadmissible phase regime classifications, execute intervention on the active trajectory comprising at least one of backtracking to a geometric anchor, redirection along an alternative admissible path, interruption of the trajectory, or suspension pending additional input; and
condition output generation on trajectory admissibility status by emitting a response when the trajectory remains epistemically admissible, qualifying a response when an admissible prefix exists, or suppressing output when no admissible trajectory supports a response.

2. The computer system of claim 1, wherein the epistemic connection assigns edge phase values using an evidential consistency function comprising a source consistency component, a cross-modal corroboration component, and a temporal stability component, the component values being combined and mapped to a phase interval such that full consistency maps to zero phase and zero consistency maps to a maximal phase value.

3. The computer system of claim 1, wherein the software instructions further detect epistemic instability during open-path traversal prior to loop closure by monitoring transported holonomy descriptors from different source paths and identifying contradictory phase assessments at a current traversal location.

4. The computer system of claim 1, wherein corroboration of a conclusion reached along a trajectory classified in the drift regime requires an independent corroborating trajectory that reaches a cognitive state within a proximity threshold of the original conclusion, maintains accumulated epistemic phase within the coherent regime, and is not deformable into the original trajectory within the latent manifold.

5. The computer system of claim 4, wherein the non-deformability condition is evaluated using homotopy class identifiers or reachability equivalence under barrier edge constraints derived from consolidated regions of the latent manifold.

6. The computer system of claim 1, wherein the software instructions further create geometric anchors during forward trajectory traversal at locations where trajectory bifurcations, goal potential extrema, or curvature anomalies are detected, each geometric anchor storing local manifold state sufficient to enable return navigation.

7. The computer system of claim 1, wherein backtracking is implemented by inverting geometric flow dynamics through stored trajectories to return to a geometric anchor, and wherein redirection is implemented by computing an alternative geodesic path that avoids a region of detected instability while pursuing an active goal potential field configuration.

8. The computer system of claim 1, wherein the software instructions further evaluate epistemic admissibility of incoming cognitive states prior to trajectory formation by projecting each incoming state to a provisional location on the latent manifold and classifying admission outcomes as absorption, flagging at reduced commitment, boundary defect recording, or veto.

9. The computer system of claim 1, wherein the software instructions further manage consolidation of regions of the latent manifold into irreversible reservoirs, gating consolidation on concurrent satisfaction of epistemic admissibility, epistemic coherence or corroboration, and capacity admissibility.

10. The computer system of claim 9, wherein the software instructions further process inadmissible trajectories by generating abstract constraint representations and projecting the constraint representations into irreversible reservoirs through a non-invertible operation that discards reconstructable trajectory details while preserving information usable to identify structurally similar inadmissible patterns.

11. The computer system of claim 9, wherein the software instructions further apply asymmetric constraint feedback from the irreversible reservoirs to influence subsequent admissibility evaluations and traversal decisions, wherein active reasoning does not modify contents of the irreversible reservoirs.

12. The computer system of claim 1, wherein the software instructions further update geometric structures of the latent manifold on separated timescales comprising a fast timescale for projection events, an intermediate timescale for compression flow, and a slow timescale for connection relaxation that reduces epistemic curvature, wherein decreasing background epistemic curvature increases sensitivity of phase drift detection during subsequent traversal.

13. The computer system of claim 1, wherein the goal attraction is provided by goal potential fields generated by a goal manager that creates scalar fields over the latent manifold representing task-alignment of different regions and continuously updates the goal potential fields based on changing objectives.

14. The computer system of claim 1, wherein qualifying a response comprises deriving output from an admissible prefix of the trajectory and including structured indications of epistemic insufficiency identifying evidential gaps encountered during traversal.

15. The computer system of claim 1, wherein suppressing output comprises generating a suppression response selected from withholding a response, requesting clarification, or deferring response, wherein suppression is a defined architectural state rather than an error condition.

16. The computer system of claim 1, wherein the software instructions further perform autonomous manifold reorganization during off-task periods by sampling thought bundles and applying stochastic perturbations informed by local curvature to test stability and identify opportunities for consolidation or abstraction.

17. The computer system of claim 1, wherein the software instructions further classify detected closed reasoning paths using curvature type decomposition into components compatible and incompatible with an almost-complex structure maintained on the latent manifold, and forward phase regime classifications together with the curvature type decomposition for use in consolidation gating.

18. The computer system of claim 9, wherein the software instructions further support localized revision of consolidated regions when contradictory boundary events accumulate beyond a revision threshold.

19. The computer system of claim 1, wherein the latent manifold maintains thought bundles comprising compact submanifolds, and wherein traversal navigates through the thought bundles while retrieving stored thoughts based on geometric proximity and semantic alignment.

20. The computer system of claim 1, wherein the intervention is executed within the cognitive dynamics engine as a modified geometric computation within the same substrate that computed the original trajectory.
